(19) United States
(12) Patent Application Publication
(10) Pub. No.: US 2017/0116551 A1
(43) Pub. Date: Apr. 27, 2017

(54) CREW SCHEDULING SYSTEM AND CREW SCHEDULING METHOD

(71) Applicants: Kabushiki Kaisha Toshiba, Tokyo (JP); TOSHIBA SOLUTIONS CORPORATION, Kawasaki-shi (JP)

(72) Inventor: Hideki KUBO, Tokyo (JP)

(73) Assignees: Kabushiki Kaisha Toshiba; TOSHIBA SOLUTIONS CORPORATION

(21) Appl. No.: 15/399,533

(22) Filed: Jan. 5, 2017

Related U.S. Application Data
(63) Continuation of application No. PCT/JP2014/003626, filed on Jul. 8, 2014.

(51) Int. Cl. G06Q 10/06; G08G 1/123; G06Q 10/10

(52) U.S. Cl. CPC G06Q 10/06313; G06Q 10/06311; G06Q 10/1093; G08G 1/123; G06Q 50/30

(57) ABSTRACT

A block segmentation unit is configured to obtain a segmentation number for segmenting a vehicle operation schedule in the unit of a predetermined target time, compute costs of each trip segmented at any one of predetermined segmentation candidate points, determine a segmentation point having the lowest cost, and segment the vehicle operation schedule into the trips. In addition, a duty structuring unit is configured to set a consecutive structuring number of the trip segments, and determine whether or not the segmentation number is evenly divided by the consecutive structuring number for each of the vehicle operation schedules. For the vehicle operation schedule in which the segmentation number is not evenly divided by the consecutive structuring number, patterns of combinations of consecutive block structured by the consecutive structuring number and residual trips are enumerated, and block are structured by combining the residual trips of each of the patterns and residual trips of each of patterns of other vehicle operation schedules.

### CROSS-REFERENCE TO RELATED APPLICATION

This application is a continuation of prior International Application No.PCT/JP2014/003626 filed on Jul. 8, 2014, the entire contents of which are incorporated herein by reference.

### FIELD

Embodiments of the present invention relate to a crew scheduling system and a crew scheduling method applicable to transportation businesses such as train or bus routes or a long-range truck delivery service.

### BACKGROUND

The following comments include several industry terms, the terms defined as follows:
1. “Trip” defines a travel range of a crew boarding a vehicle or being in service, and absolutely means the boarding or the service;
2. “Block” defines a block which includes the crew boarding a vehicle to operate the vehicle several times. The crew has a break between each time. More specifically, plural trips are combined to mean a block;
3. “Duty” defines work of the crew. The work includes the above-defined blocks further combined with each other; and
4. “Relief” defines a change where the crew changes places with another crew.

In train or bus businesses, a vehicle is daily operated from early morning to midnight. In this case, a crew relief is performed considering their daily on-duty time depending on a vehicle operation schedule. For example, assuming that a vehicle is operated from early morning to midnight, three crew members may relief by dividing the operation schedule into a morning-midday period, a midday-evening period, and an evening-midnight period.

If a daily on-duty time of a crew member is regulated to eight hours, a continuous work is allowed during that period of time while continuous one-way trip for eight hours is avoided. If a route is short, and a train turns around at a terminus, a crew member may take a rest at the terminus In this case, a trip is not continuous, and a crew member may work for eight hours continuously. However, if a route is long, and a continuous trip time is long, a relief is necessary in the middle of the route considering safety. For example, if a crew member makes a trip continuously for three hours, the crew member may be allowed to take a rest for one hour. If this course is repeated twice, a daily work time may be satisfied.

On this background, in many cases, a crew duty (a unit of work to be finished by a crew member during a single work day) is created in the unit of a daily 8-hour work by combining a short trip obtained by segmenting a vehicle operation schedule with another trip obtained by segmenting other vehicle operation schedules.

Meanwhile, an employer of a train or bus transportation company wants to make crew duty by minimizing the number of crew members and the rest time as small as possible in order to reduce costs of crew members while considering safety as described above.

In the prior art, a planner makes a trial-and-error technique to find a combination of trip and a structured crew duty satisfying an optimum condition in terms of cost while guaranteeing safety. However, there are a lot of timings that may be used to segment trip, and the number of duty obtained by combining the timings is also infinite. A process of verifying and analyzing such abundant combinations of trips is difficult for a human. Therefore, trips and duty are selected by excluding some combinations at a certain range. For this reason, it is difficult to say that a genuine optimum trip can be obtained.

In this regard, many systems of the prior art have tried to systemize this processing using a computer and compute all possible combinations to find an optimum combination. In such a system, all possible patterns of trip segments are enumerated, and computation is performed for all of the combinations to find an optimum duty. However, as a crew member has the shorter trip (as the segmentation number of the vehicle operation schedule increases), the number of patterns of trip segments increases, and the number of combinations increases accordingly. This computation takes a long time. In such a system, several hours may be taken to compute an optimum combination. For this reason, the number of combinations remarkably increases in the case of a big company, and it may be difficult to obtain a processing result within an allowable time.

For this reason, in a system of the prior art, various techniques have been proposed to reduce a computation load. For example, out of a plurality of combinations, a condition for removing necessity of computation is defined, and a combination pruning is performed. Alternatively, a segmentation pattern of trips or a duty structuring pattern may be determined in advance. This has contributed to computation load reduction and high-speed processing.

However, considering that a route condition or a vehicle operation condition is different depending on a company. Therefore, in the technique described above, the selected pattern was customized to be unique to the corresponding company. Therefore, it was difficult to generalize the technique. In this regard, it is desirable to provide a generalized technology capable of reducing the computation load and enabling fast processing.

In this manner, in the system of the prior art, when the trip segments are structured, all of the trips included in a vehicle operation schedule were used to create combinations across the vehicle operation schedules. Therefore, an optimum combination was found from an infinite number of combinations. For this reason, as the number of trip segments increases, the number of trips remarkably increases. Accordingly, the number of combinations of trips also increases. This processing takes a very long time. In this regard, the processing load was reduced by selectively excluding the combinations or adding conditions in the prior art. However, it is also difficult to generalize this technique.

### BRIEF DESCRIPTION OF THE DRAWINGS

FIG. 1 is an explanatory diagram illustrating a vehicle operation schedule according to an embodiment of the invention;

FIG. 2 is a diagram illustrating residual trips of the vehicle operation schedule according to an embodiment of the invention;

FIG. 3 is a diagram illustrating where a residual trip of the vehicle operation schedule according to an embodiment of the invention is generated;

FIG. 4 is a block diagram illustrating a crew scheduling system according to an embodiment of the invention;

FIG. 5 is a block diagram illustrating a crew scheduling system according to an embodiment of the invention configured through a network such as the Web or the Cloud;

FIG. 6 is a flowchart illustrating a block segmentation process according to an embodiment of the invention;

FIG. 7 is a diagram illustrating a setting screen used in the block segmentation process according to an embodiment of the invention;

FIG. 8 is a scheduling diagram illustrating the block segmentation process according to an embodiment of the invention;

FIG. 9 is a diagram illustrating cost calculation for the trips segmented according to an embodiment of the invention;

FIG. 10 is a flowchart illustrating a duty structuring process according to an embodiment of the invention;

FIG. 11 is a diagram illustrating a setting screen for the duty structuring process according to an embodiment of the invention;

FIG. 12 is a diagram illustrating a duty structuring process according to an embodiment of the invention in which no residual trip is generated;

FIG. 13A is a diagram illustrating a duty structuring process according to an embodiment of the invention in which a residual trip is generated;

FIG. 13B is a diagram illustrating a duty structuring process according to an embodiment of the invention in which a residual trip is generated;

FIG. 14 is a diagram illustrating a distribution of residual trips generated from each vehicle operation schedule according to an embodiment of the invention;

FIG. 15 is a diagram illustrating combinations of residual trips for each vehicle operation schedule according to an embodiment of the invention;

FIG. 16 is a diagram illustrating whether or not a work time counter of the residual trips structured according to an embodiment of the invention is within an allowable range;

FIG. 17 is a diagram illustrating an actual example of a route map according to an embodiment of the invention;

FIG. 18 is a scheduling diagram illustrating an actual example for a plurality of vehicle operation schedules according to an embodiment of the invention;

FIG. 19 is a diagram illustrating a relationship between the scheduling diagram of Operation Schedule 1 of FIG. 18 and the segmented trips;

FIG. 20 is a diagram illustrating a relationship between the scheduling diagram of Operation Schedule 2 of FIG. 18 and the segmented trips;

FIG. 21 is a diagram illustrating a relationship between the scheduling diagram of Operation Schedule 3 of FIG. 18 and the segmented trips;

FIG. 22 is a diagram illustrating a relationship between the scheduling diagram of Operation Schedule 4 of FIG. 18 and the segmented trips;

FIG. 23 is a diagram illustrating the residual trips generated in Operations Schedules 1 and 4 of FIG. 18 and their combinations; and

FIG. 24 is a diagram obtained by generalizing a combination of the trips in an actual example according to an embodiment of the invention, in which for explain on the computation number of their combinations.

### DETAILED DESCRIPTION

A crew scheduling system and a crew scheduling method according to the embodiment capable of preventing a user from being unable to complete crew scheduling within an allowable time due to a remarkable increase of the number of combinations and providing high-speed processing and generalization.

According to an aspect of the present disclosure, there is provided a crew scheduling system including: a block segmentation unit configured to obtain a segmentation number for segmenting a vehicle operation schedule from a departure to a terminus of the vehicle in the unit of a predetermined target time, compute costs of each trip segmented by the segmentation number at any one of a plurality of predetermined segmentation candidate points, determine a segmentation point having the lowest cost, and segment the vehicle operation schedule into the trips; and a duty structuring unit configured to set a consecutive structuring number of the trip segments, determine whether or not the segmentation number is evenly divided by the consecutive structuring number for each of the vehicle operation schedules, enumerate patterns of combinations of consecutive trips structured by the consecutive structuring number and residual trips for the vehicle operation schedule in which the segmentation number is not evenly divided by the consecutive structuring number, structure trips in the unit of the consecutive structuring number by combining the residual trips of each of the patterns and residual trips of each of patterns of other vehicle operation schedules, compute costs of the block structured in the unit of the consecutive structuring number when the block structured in the unit of the consecutive structuring number are within a predetermined range of the structured block allowance time, and select the block structured with the lowest cost as a crew duty.

According to an embodiment, it is possible to reduce the number of combinations by combining only residual trips remaining after combining consecutive trips. That is, all possible combinations of trips are not computed. Instead, only residual trips except for consecutive trips are used in computation of combinations. In this manner, since only residual trips remaining in every vehicle operation schedule are combined, the number of combinations is limited. Therefore, it is possible to provide high-speed processing and generalization.

First, a basic concept of the embodiment of the present invention will be described. In this embodiment, a two-step process including block segmentation and block structuring is performed in order to reduce the number of combinations when a crew duty k schedule is created.

In the block segmentation, a target time value after segmenting the trips is set, and depots where a crew relief is allowed are set as segmentation candidate points. In addition, which of the set segmentation candidate points is suitable for segmenting the vehicle operation schedule is computed in terms of costs, and a segment point where a minimum cost can be obtained is specified, so that segment points of the vehicle operation schedule are determined

In the block structuring, a crew duty is created by obtaining an optimum combination using the segmented trips. In this case, assuming that a continuous trip on the same vehicle is more efficient, first, combinations of consecutive trips suitable for the structuring condition (consecutive structuring number) out of the vehicle operation schedule are created as many as possible, and they are set in a duty. Next, any trip remaining in the vehicle operation schedule after combining the consecutive trips as described above is also combined with a trip remaining after combining the trips of other vehicle operation schedules, and they are set in the duty. A combination capable of obtaining an optimum duty is determined out of the duty structured by these remaining trips. That is, whether or not the work time can be minimized, or whether or not a minimum rest time is guaranteed is expressed in term of costs, and a combination capable of obtaining an optimum duty is determined Using such a computation method, it is possible to reduce the number of combinations and rapidly find an optimum duty.

In this method, basically, it is assumed that a continuous trip on the same vehicle operation schedule is most efficient. Therefore, continuity of the trips s is initially considered, and a consecutive structuring number for consecutively structuring the trips is initially determined For example, if the trips s are segmented by a target time of two hours, and the trips is set to eight hours, the consecutive structuring number is determined as “four.” Using this consecutive structuring number, the trips on the same vehicle operation schedule are structured. As a result, if a continuous duty is appropriately structured without generating a residual trip, it is considered a duty is established, and the corresponding trip is excluded in the subsequent processing. Otherwise, for the vehicle operation schedule having a residue (residual) trip, the trips are structured by considering continuity as described above, and patterns are extracted regarding where the residual trip 4 is generated as a result thereof. Then, an optimum duty is found by combining patterns of the residual trips. Naturally, if the combination of the residual trips is determined, the consecutive trips are also determined

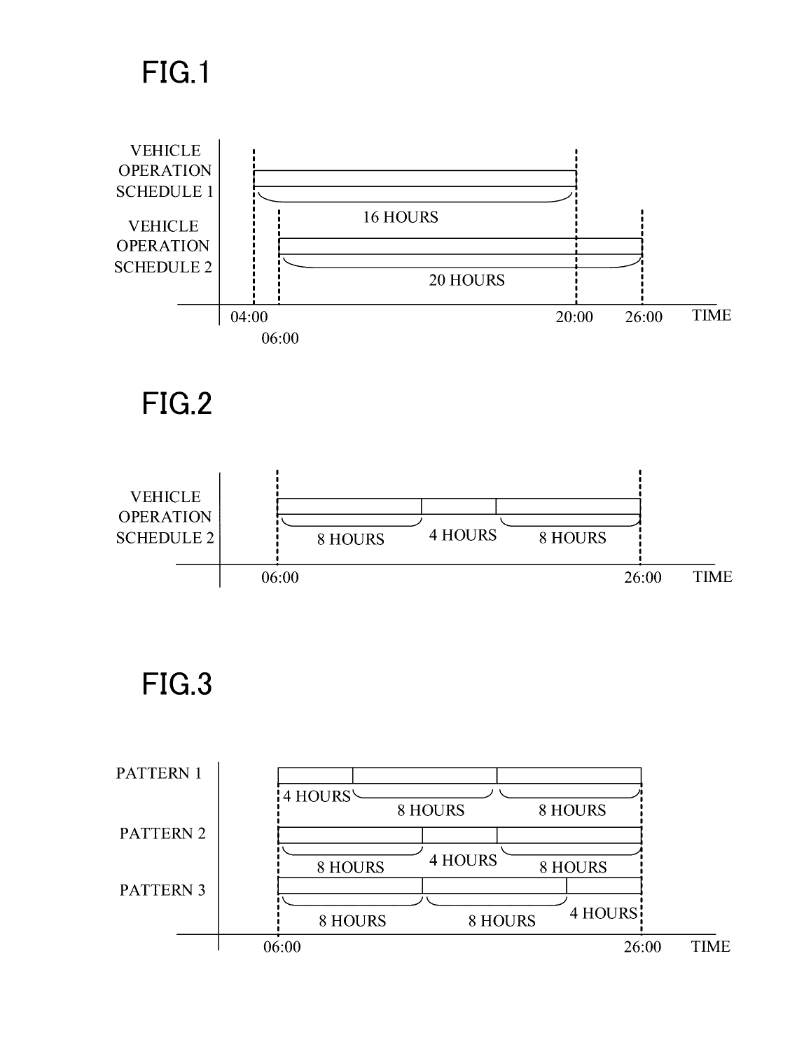

For example, it is assumed that a pair of vehicle operation schedules including a vehicle operation schedule 1 for 16 hours from 04:00 to 20:00 and a vehicle operation schedule 2 for 20 hours from 06:00 to 02:00 next day are provided as illustrated in FIG. 1. Assuming that an on-duty time of a crew member is basically defined as eight hours, the vehicle operation schedule 1 requires two crew members for a period of eight hours from 04:00 to 12:00 and another period of eight hours from 12:00 to 20:00. As a result, eight hours are allocated to each crew member without a gap, and a single vehicle can be operated without any extra duty. Therefore, there is no time wasting. In the case of the vehicle operation schedule 2, when the on-duty time is set to eight hours, four hours remain as a residue. If a trip is divided in this manner, two eight-hour trips and a single four-hour trip are generated. In this case, the four-hour trip is combined with another residual four-hour trip generated from any other vehicle operation schedule so as to be complemented as an eight-hour trip.

In the example described above, the residual four hours are centered in the vehicle operation schedule. Alternatively, depending on the combined trip, the residual trip may be allocated to an early trip (Pattern 1) or a night trip (Pattern 3) as illustrated in FIG. 3.

As a result, it is conceived that a duty of a crew member is obtained by combining a pair of four-hour trips in an eight-hour duty time (consecutive structuring number=“2”). Although the vehicle operation schedule serving as a basis of crew scheduling has various lengths, the vehicle operation schedule is segmented into four-hour trips, and residual four-hour trips are structured with each other. Out of those combinations, a combination having least time wasting (in which there is no vacancy between the trips, and thus, a total on-duty time is shortest) is most desirable. That is, a pair of consecutive trips in the same vehicle operation schedule essentially has no time wasting, and there is no necessity of combination.

When a residual trip is generated, the on-duty time is calculated as frequent as the number of places where a residual trip is likely generated in each vehicle operation schedule and the number of combinations across the vehicle operation schedules. A combination having the minimum on-duty time is set as a combination of residual trips having least time wasting. A pair of consecutive trips obtained by combining the residual trips is confirmed in the entire vehicle operation schedule.

In this concept, when a block is created, a target time for segmenting the vehicle operation schedule is determined first. That is, an eight-hour trip may be bisected into two four-hour trips, may be trisected into three two-hour/forty-minute trips, and so on. This time segment is set as a target, and a vehicle operation schedule is segmented into trips such that the segmented trip is closer to this time segment. The trips are re-structured using this trip segments by a predetermined consecutive structuring number. In this case, when a residual trip is generated, a block may be efficiently created by combining the residual trips with each other.

When higher accuracy is required, the segmentation accuracy can be improved by increasing the segmentation number. However, if the segmentation number increases, the number of residual trips and a possibility of generating a residual trip also increase. Therefore, the number of combinations across the vehicle operation schedules increases. However, compared to a technique of the prior art in which overall trips are combined, the number of combinations is remarkably reduced because only the residual trips are combined.

In general, a vehicle serving as a basis of the block is operated from early morning to midnight, and the vehicle operation schedule thereof is continuously applied by changing a plurality of crew members. In this embodiment, a block is created by combining a plurality of trips depending on various conditions, and the combinations are analyzed in a round robin manner in terms of costs, so that an optimum trip having the minimum cost is selected, and segmentation is performed accordingly.

In this process, there is no condition that depends on an individual railway company such as a pattern unique to the company's route. Instead, a computation load can be reduced, and a fast processing can be provided just by considering a combination of the trips or the duty time.

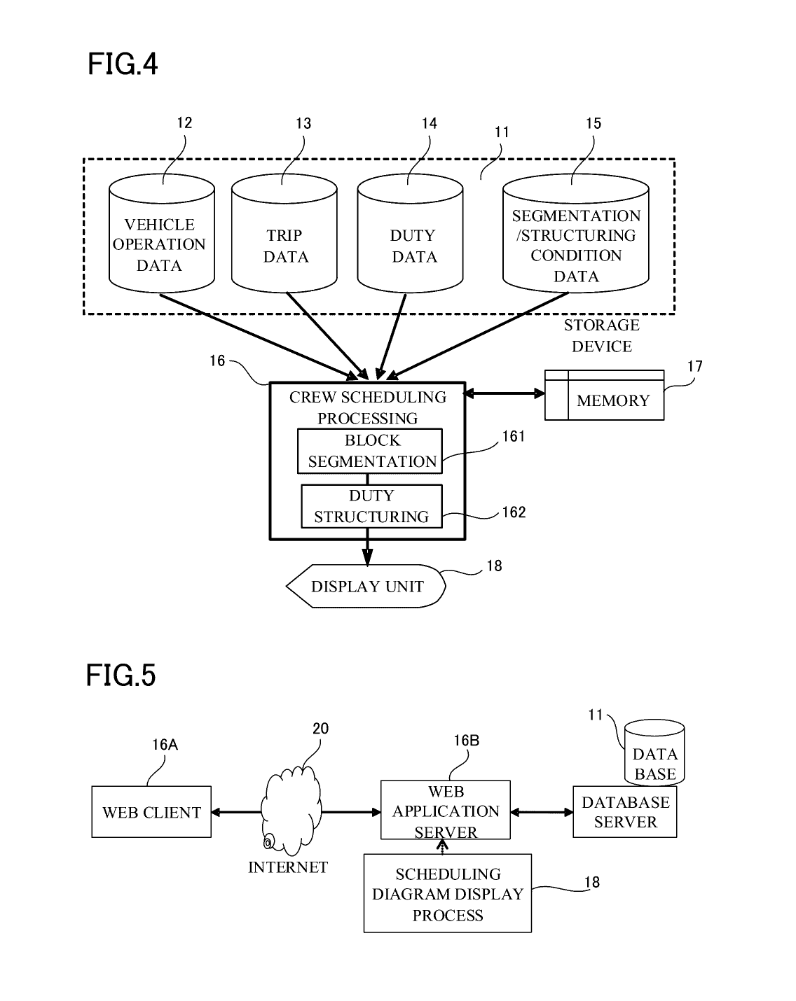

A crew scheduling system according to an embodiment of the invention will now be described in detail. As illustrated in FIG. 4, the crew scheduling system has a crew scheduling processing unit 16 configured to automatically create a duty from a structure of the block using vehicle operation data 12 stored in a storage device 11, trip data 13, duty data 14 and conditional data 15 necessary in the segmentation and structuring. The crew scheduling processing unit 16 has a block segmentation unit 161 and a duty structuring unit 162 to perform a two-step processing using these units 161 and 162. In the first stage, the 1 block segmentation unit 161 creates the trip data 13 from the vehicle operation data 12 by dividing the vehicle operation schedule using a cost computation formula described below on the basis of the conditional data. In the next stage, the duty structuring unit 162 extracts only residual trips other than consecutively structured trips from information regarding the distributed trips on the basis of the segmentation/structuring conditional data 15. In addition, duty data 14 as a combination of the trips are created by combining the residual trips on the basis of computation of the on-duty time or the like in terms of costs.

That is, the block segmentation unit 161 first obtains a segmentation number “d” for segmenting the vehicle operation schedule in the unit of a predetermined target time from a departure to a terminus of the vehicle. Next, costs are calculated for each trip by segmenting the vehicle operation schedule using any one of plural predetermined segmentation candidate points to determine a segment point having the minimum cost. Then, the vehicle operation schedule is segmented on the basis of the segment point.

The duty structuring unit 162 first determines a consecutive structuring number “s” for the trip segments. Then, it is determined whether or not the segmentation number “d” is evenly divided by the consecutive structuring number “s” for each vehicle operation schedule. For the vehicle operation schedule not evenly dividable, patterns of combinations between consecutive trips structured by the consecutive structuring number “s” and residual trips are enumerated, and the residual trips of these patterns are combined with residual trips of each pattern of other vehicle operation schedules. In addition, the residual trips are structured by the consecutive structuring number “s.” If a total time of the structured trips is within a predetermined allowable time range of the structured trips, the cost of the trips structured by the consecutive structuring number “s” is calculated. As a result, one of the structured trips having the lowest cost is set in a crew duty.

Note that the memory 17 of FIG. 4 temporarily holds various data generated in the processing procedures described above. In addition, the display unit 18 displays the resulting crew duty.

Note that, although the system configuration of FIG. 4 is configured in a single computer, the same configuration may be possible in a distributed manner through a network 20 such as the Web 16A or the Cloud 16B as illustrated in FIG. 5.

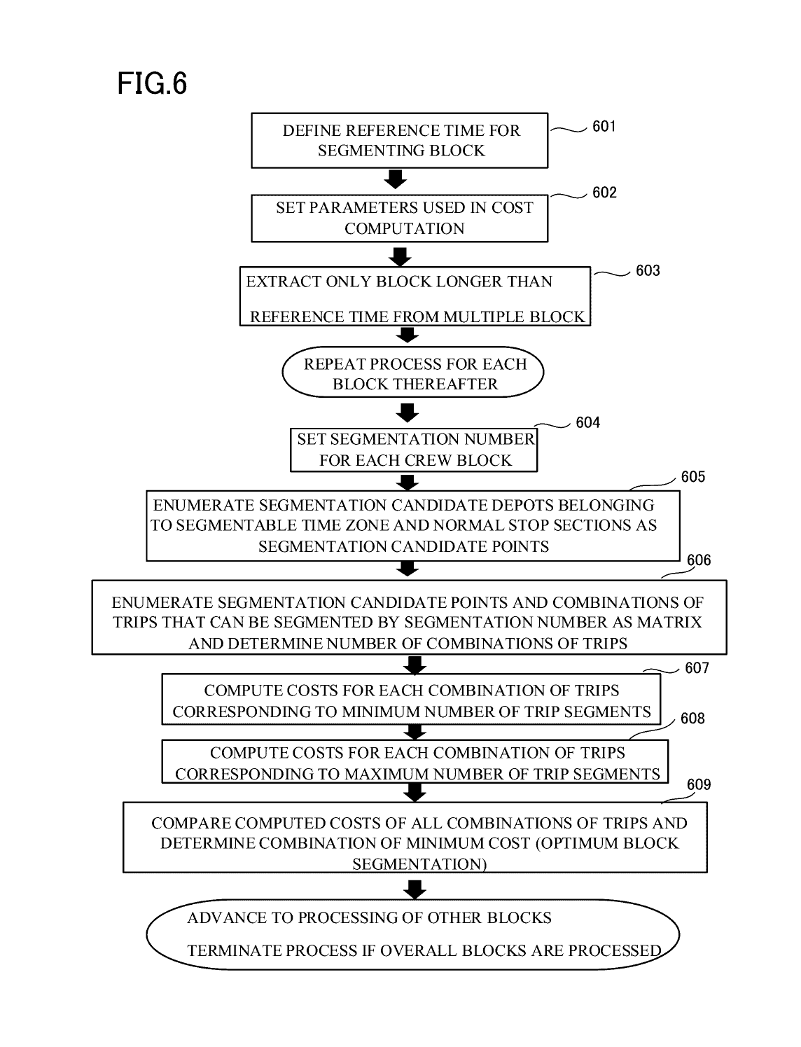

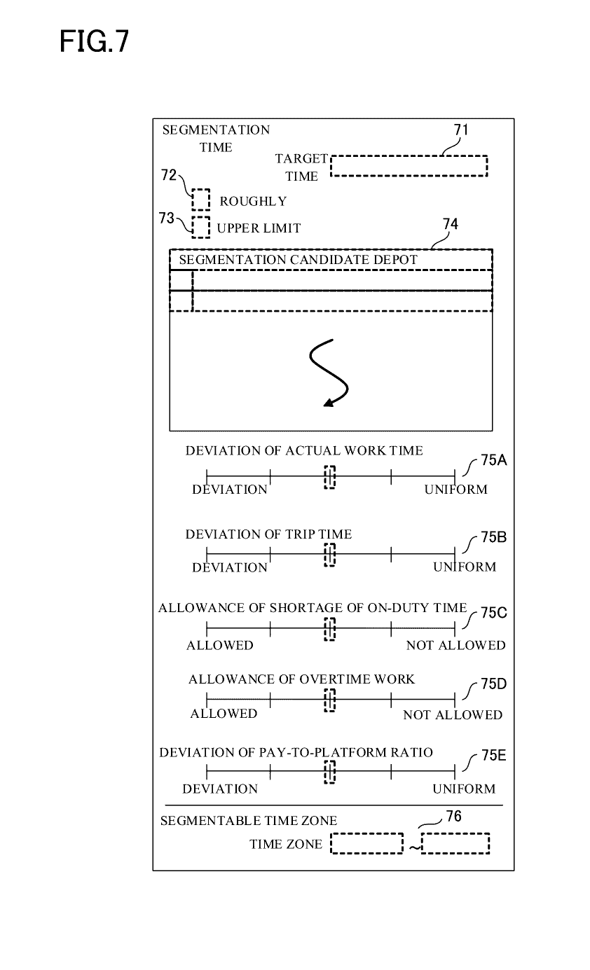

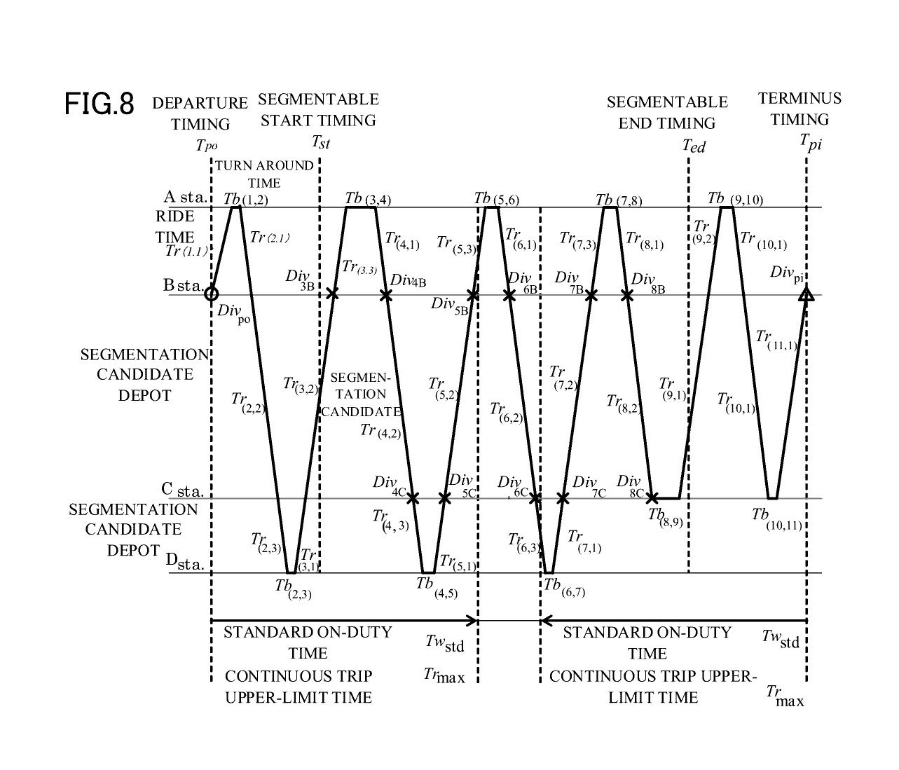

Next, a processing of the aforementioned block segmentation unit 161 will be described with reference to the flowchart of FIG. 6, the setting screen of FIG. 7, and the scheduling diagram of the vehicle operation schedule to be segmented of FIG. 8.

First, a vehicle operation schedule to be segmented will be described with reference to FIG. 8. FIG. 8 illustrates a train scheduling diagram in which a train trips between Depot A (hereinafter, referred to as “Station A”) and Depot D (hereinafter, referred to as “Station D). Between Stations A and D, Depots B and C (hereinafter, referred to as “Stations B and C” are built, where a crew relief is allowed. Since a crew relief is allowed in Stations B and C, the block can be segmented in these Stations B and C. These stations B and C will also be called “segmentation candidate points.”

In FIG. 8, a train departs from Station B at the timing Tpo and arrives at Station B at the timing Tpi. The time elapsing there between corresponds to a vehicle operation time Trun. “Tr(i, j)” denotes an interstation trip time. For example, “Tr(1,1)” denotes a trip time from Station B to Station A, “Tr(2,1)” denotes a trip time from Station A to Station B, “Tr(2,2)” denotes a trip time from Station B to Station C, . . . , and so on.

“Tb(i, j)” denotes a rest time in a turnaround station. For example, “Tb(1,2),” “Tb(3,4),” “Tb(5,6),” “Tb(7,8),” and “Tb(9,10)” denote rest times at a turnaround station A, “Tb(2,3),” “Tb(4,5),” and “Tb(6,7)” denotes rest times at a turnaround station D, and “Tb(8,9),” and “Tb(10,11)” denote rest times at a turnaround station C.

“Tst” denotes a segmentation start timing, and “Ted” denotes a segmentation end timing. That is, the block segmentation is allowed in Stations B and C between these timings Tst and Ted. “Div_{3B} to Div_{8B}” and “Div_{4C} to Div_{8C}” denote segmentation candidate points.

FIG. 7 shows an exemplary setting screen for setting various values used in the processing of the block segmentation unit 161.

In FIG. 7, a selection box “TARGET TIME” 71 is used to select a reference time for segmenting a vehicle operation schedule. If a standard on-duty time is set to eight hours and is bisected for each crew member, the target time is set to “four hours.”

Selection buttons 72 and 73 are used to select “ROUGHLY” or “UPPER LIMIT” as a condition for determining a continuous trip time. If the selection button “ROUGHLY” 72 is selected, the continuous trip time may exceed an upper limit period or not. In contrast, if the selection button “UPPER LIMIT” 72 is selected, the continuous trip time is not allowed to exceed the upper limit time.

A selection box “SEGMENTATION CANDIDATE DEPOT” 74 is used to select the segmentation candidate depot for segmenting the vehicle operation schedule (Stations B and C in FIG. 8). In this case, a plurality of segmentation candidate depots may be selected.

Deviation setting portions 75A to 75E are used to change coefficients (weight) of the cost computation formula described below to desired values.

A selection box “SEGMEN[TABLE TIME ZONE” 76 is used to limit a time zone allowed for segmentation, where the segmentation start timing Tst and the segmentation end timing Ted of FIG. 8 are input.

Next, the processing will be described in more detail with reference to the flowchart of FIG. 6.

Process 601: Define Reference Time for Segmenting Block.

As described below, there are two types of target times including (1) an allowable overwork time such as a work time, and (2) a time set as an upper limit of the continuous trip for safety purposes. The segmentation number is differently considered depending on which type of target time is selected.

(1) Example of time serving as reference of segmentation

Standard on-duty time ex) 8 h00 m

(2) Example of time segmented not to exceed upper limit

Continuous trip upper limit time ex) 4 h30 m

Process 602: Set Parameters Used in Cost Computation

(described below)

A determination reference may be changed by increasing or decreasing parameters depending on what is to be focused on in the block segmentation. Such parameters are set in advance.

Process 603: Extract Only Block Longer than Reference Time from Multiple Blocks

There are various lengths of vehicle operation schedules. The block not necessitating segmentation are excluded before a start of the processing. Those longer than the segmentation reference time are set as segmentation target block.

Process 604: Set Segmentation Number for Each Block

After this step, the processing is performed for each vehicle operation schedule.

A vehicle operation schedule is divided by the segmentation reference time defined in advance to compute the number of trips to be segmented. This segmentation number is not set to a singular number but may be a plurality of candidates.

As described above, two types of conditions are provided to determine the continuous trip time, that is, (1) ROUGHLY or (2) UPPER LIMIT. Either condition may be selected to perform segmentation.

(1) ROUGHLY

If the segmentation target time is set, and “ROUGHLY” is selected, an optimum segmentation point having the lowest cost is selected regardless of whether or not the continuous trip time exceeds the target time. The “ROUGHLY” is selected when a user wants to segment block before or after the target time because it is difficult to easily perform a crew relief in a suitable place as in a long-range bus journey or a truck transportation.

(2) UPPER LIMIT

If the segmentation target time is set, and then “UPPER LIMIT” is selected, an optimum segmentation point having the lowest cost is selected while the continuous trip time is inhibited to exceed the target time. The “UPPER LIMIT” is selected when a mandatory continuous trip time is specified on a regulation or rule as in a railway system, and exceeding the mandatory continuous trip time is inhibited.

Here, the aforementioned “time serving as reference of segmentation” is set to “ROUGHLY” as a target time, the block segmentation number “d” is obtained as follows.

If the vehicle operation time is set to Trun(=Tpi−Tpo), and the target time is set to the standard on-duty time Tstd, a block segmentation minimum optimum value dₘᵢₙ, and a block segmentation maximum optimum value dₘₐₓ are obtained as the following equations (1) and (2).

$$[ Math . 1 ]$$

$$\begin{matrix}{d}_{min} = INT ( \frac{{T}_{run}}{{Tw}_{std}} ) & ( 1 ) \\ {d}_{max} = INT ( \frac{{T}_{run}}{{Tw}_{std}} ) + 1 & ( 2 )\end{matrix}$$

For example, it is assumed that a train is operated from 05:00 to 22:00.

In this case, the following times are obtained.

vehicle operation time Trun=17 h00 m

standard on-duty time Tstd=8 h00 m

block segment minimum optimum value dₘᵢₙ=2

block segment maximum optimum value dₘₐₓ=3

In contrast, if “UPPER LIMIT” is selected using the “time segmented not to exceed the upper limit,” the block segmentation number “d” is obtained as follows.

Similarly, in this case, if the vehicle operation time is set to Trun(=Tpi−Tpo), and the target time is set to the continuous trip upper limit time Trₘₐₓ, the block segmentation minimum optimum value dₘᵢₙ and the block segmentation maximum optimum value dₘₐₓ are obtained as the following equations (3) and (4).

$$[ Math . 2 ]$$

$$\begin{matrix}{d}_{min} = INT ( \frac{{T}_{run}}{{Tr}_{max}} ) + 1 & ( 3 ) \\ {d}_{max} = {d}_{min} + 1 & ( 4 )\end{matrix}$$

For example, it is assumed that a train is operated from 05:00 to 22:00.

In this case, the following times are obtained.

vehicle operation time Trun=17 h00 m

continuous trip upper limit time Trₘₐₓ=4 h30 m

block segment minimum optimum value dₘᵢₙ=4

block segment maximum optimum value dₘₐₓ=5

Process 605: Enumerate Segmentation Candidate Depots Belonging to Segmentable Time Zone and Normal Stop Sections as Segmentation Candidate Points.

Starting from a block start side, segmentation candidate depots belonging to a segmentable time zone and train stop stations are enumerated as the segmentation candidate points. If there is no candidate, the processing for this block is terminated.

In the case of FIG. 8, the segmentation candidates may be enumerated in the following sequence.

Div_{3B} Div_{4B} Div_{4C} Div_{5C} Div_{8B} Div_{6B} Div_{6C} Div_{7C} Div_{7B} Div_{8B} Div_{8C}

PROCESS 606: ENUMERATE SEGMENTATION CANDIDATE POINTS AND COMBINATIONS OF TRIPS THAT CAN BE SEGMENTED BY SEGMENTATION NUMBER AS MATRIX. On the basis of this enumeration, the number of combinations of trips is determined.

Since the block segmentation number “d” includes the block segmentation minimum optimum value dₘᵢₙ and the block segmentation maximum optimum value dₘₐₓ, the matrices are created for each value.

If the aforementioned “time serving as reference of segmentation” is set as the target time, the segmentation candidates can be enumerated as follows.

When the block segmentation minimum optimum value dₘᵢₙ is set to “2” as the block segmentation number “d,”

TABLE 1

| | |
|---|---|
| trips matrix n when “d = 2” | 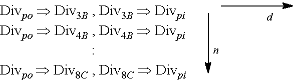 |

When the block segmentation maximum optimum value dₘₐₓ is set to “3” as the block segmentation number “d,”

TABLE 2

| | |
|---|---|
| trips matrix n when “d = 3” | $( \begin{matrix}\begin{matrix}{Div}_{po} ⇒ {Div}_{3 B} & , {Div}_{3 B} ⇒ {Div}_{4 B} , {Div}_{4 B} ⇒ {Div}_{pi}\end{matrix} \\ \begin{matrix}{Div}_{po} ⇒ {Div}_{3 B} & , {Div}_{3 B} ⇒ {Div}_{4 C} , {Div}_{4 C} ⇒ {Div}_{pi}\end{matrix} \\ : \\ \begin{matrix}{Div}_{po} ⇒ {Div}_{8 B} & , {Div}_{8 B} ⇒ {Div}_{8 C} , {Div}_{8 C} ⇒ {Div}_{pi}\end{matrix}\end{matrix} )$ |

Process 607: Compute Costs for Each Combination of Trips Corresponding to Minimum Number of Block Segments

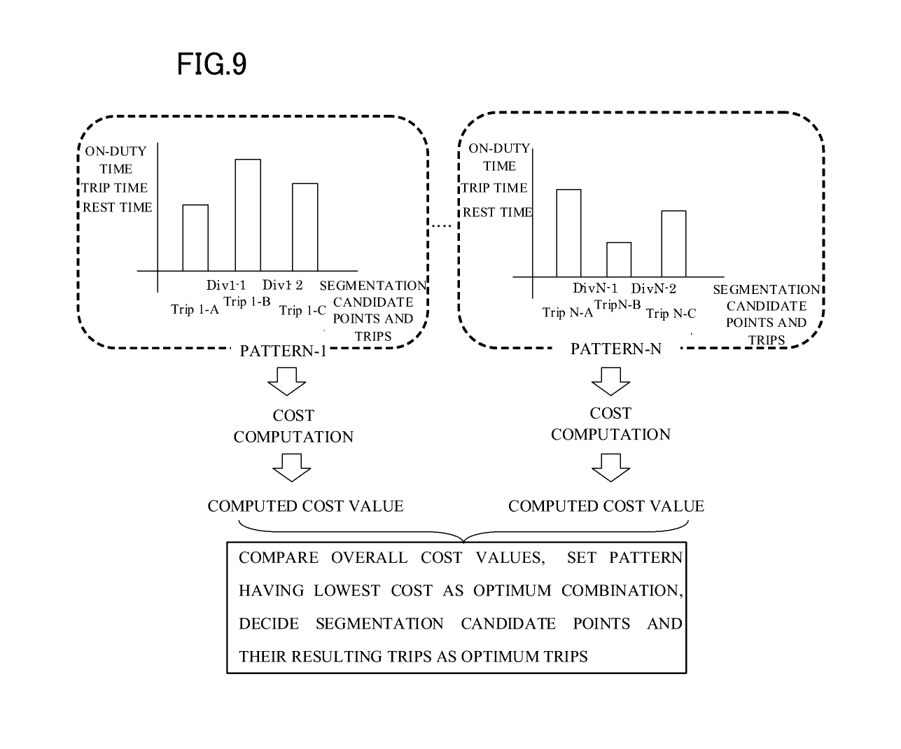

If a vehicle operation schedule is segmented, trips are generated by combining the segmentation candidate points. The trip segments do not match each other in the on-duty time, the trip time, the rest time, and the like as illustrated in FIG. 9. Most desirably, the on-duty time, the trip time, and the like are evenly distributed and do not have a difference between a plurality of trips. However, even when the on-duty time is uniform, a difference may be generated in the trip time or the rest time depending on the vehicle operation schedule. In order to quantifying this difference and determine which one is suitable, various values such as an average or a variance are calculated as described below, and they are applied as a coefficient to compute costs as illustrated in FIG. 9. In addition, a trip having the lowest cost value is defined as the most desirable combination of segmentation candidate points.

The cost computation will now be described in more detail. First, various variables are defined.

“r” denotes a train sequence number (trip number) in the vehicle operation schedule.

“r_{[d]min}” denotes a minimum train sequence number of the (d)th trip, and “r_{[d]max}” denotes a maximum train sequence number of the (d)th trip assuming that the vehicle operation schedule is segmented into “d” block.

“s_{[d]{r}}” denotes an interstation sequence in the train sequence number, and “s_{[d]{r}max}” denotes an interstation order maximum value.

“Div_{[d]min}” denotes a block segmentation start position, and “Div_{[d]max}” denotes a block segmentation end position assuming that the vehicle operation schedule is segmented into “d” block.

Then, basic times of each trips are computed assuming that the vehicle operation schedule is segmented into “d” block.

TABLE 3

| | |
|---|---|
| on-duty time of trip matrix | Tw_{[n][d]} = |
| [n][d] | T_{Div}_{_{[n][d]max}} - T_{Div}_{_{[n][d]min}} |
| Tw_{[n][d]} | |
| trip time of trip e matrix | Tr_{[n][d]} = |
| [n][d] | Σⱼ₌₁^{s}^{_{[n][d][r]max}} Σᵢ₌ᵣ_{_{[n][d]min}}^{r}^{_{[n][d]max}} |
| Tr_{[n][d]} | Tr_{[n][d](i, j)} |
| rest time of trip matrix | Tb_{[n][d]} = |
| [n][d] | Σᵢ₌ᵣ_{_{[n][d]min}}^{r}^{_{[n][d]max}}⁻¹ Tb_{[n][d](i, i+1)} |
| Tb_{[n][d]} | |

In the aforementioned table, the on-duty time refers to a total time period of a series of works from a start of a trip of a train to an end of a trip of another train. In addition, the trip time refers to a time period for which a crew member drives a train (including an intermediate stop). In addition, the rest time refers to a time period for which a crew member does not trip during turnaround and the like (a crew member gets off from a train).

Then, average values of the trips for a case where the vehicle operation schedule is segmented into “d” block are computed.

TABLE 4

| | |
|---|---|
| average on-duty time for trip combination [n] Tw_{av[n]} | ${Tw}_{av [ n ]} = \frac{{\sum }_{i = 1}^{d} {Tw}_{[ n ] [ i ]}}{d}$ |
| average trip time for trip combination [n] Tr_{av[n]} | ${Tr}_{av [ n ]} = \frac{{\sum }_{i = 1}^{d} {Tr}_{[ n ] [ i ]}}{d}$ |

Costs for each trips are computed using the aforementioned values by assuming that the vehicle operation schedule is segmented into “d” block.

TABLE 5

| | |
|---|---|
| on-duty time deviation cost for trip combination [n] C_{w[n]} (cost parameter = V₁) | ${C}_{w [ n ]} = {V}_{1} \times \frac{1}{d} {\sum }_{i = 1}^{d} {( {Tw}_{[ n ] [ i ]} - {Tw}_{av [ n ]} )}^{2}$ |
| trip time deviation cost for trip combination [n] C_{r[n]} (cost parameter = V₂) | ${C}_{r [ n ]} = {V}_{2} \times \frac{1}{d} {\sum }_{i = 1}^{d} {( {Tr}_{[ n ] [ i ]} - {Tr}_{av [ n ]} )}^{2}$ |
| on-duty time under coverage | C_{mt[n} _{]}= V₃ × Σᵢ₌₁^{d}((Tw_{av[n]} − Tw_{[n][i]}) ≧ 0)² |
| cost for trip combination [n] C_{mt[n]} | |
| (cost parameter = V₃) | |
| on-duty time over coverage | C_{ot[n]}= V₄ × Σᵢ₌₁^{d}((Tw_{[n][i]} − Tw_{av[n]}) ≧ 0)² |
| cost for trip combination [n] C_{ot[n]} | |
| (cost parameter = V₄) | |
| Pay to Platform ratio Cost C_{pp[n]} (cost parameter = V₅) | ${C}_{pp [ n ]} = {V}_{5} \times \frac{1}{d} {\sum }_{i = 1}^{d} {( 1 - \frac{{Tr}_{[ n ] [ i ]}}{{Tr}_{[ n ] [ i ]} + {Tb}_{[ n ] [ i ]}} )}^{2}$ $or$ ${C}_{pp [ n ]} = {V}_{5} \times \frac{1}{d} {\sum }_{i = 1}^{d} {( \frac{{Tb}_{[ n ] [ i ]}}{{Tr}_{[ n ] [ i ]} + {Tb}_{[ n ] [ i ]}} )}^{2}$ |

In the aforementioned table, the pay-to-platform ratio refers to a ratio of the trip time against the on-duty time.

Finally, a total cost for overall trips is computed assuming that the vehicle operation schedule is segmented into “d” block.

TABLE 6

| | |
|---|---|
| total trip cost value for trip | C_{Run[n]} = C_{w[n]} + C_{r[n]} + |
| combinations [n] C_{Run[n]} | C_{mt[n]} + C_{ot[n]} + C_{pp[n]} |

Process 608: Compute Costs for Each Combination of Trips Corresponding to Maximum Number of Block Segments

Similar to the minimum number of block segments described above, various values are obtained.

Process 609: Compare Computed Costs of All Combinations of Trips and Determine Combination of Minimum Cost (Optimum Block Segmentation).

A minimum value of the cost is selected for both the minimum and maximum number of block segments. This minimum value corresponds to the optimum block segmentation.

TABLE 7

| | |
|---|---|
| minimum cost value Cₙ_{ₒₚₜ} optimum | Cₙ_{ₒₚₜ} = min (C_{Run [n]}) |
| trip combination number nₒₚₜ | |

After completing a series of steps described above, the process advances to a processing for another block. If all of the blocks are processed, the block segmentation process is terminated.

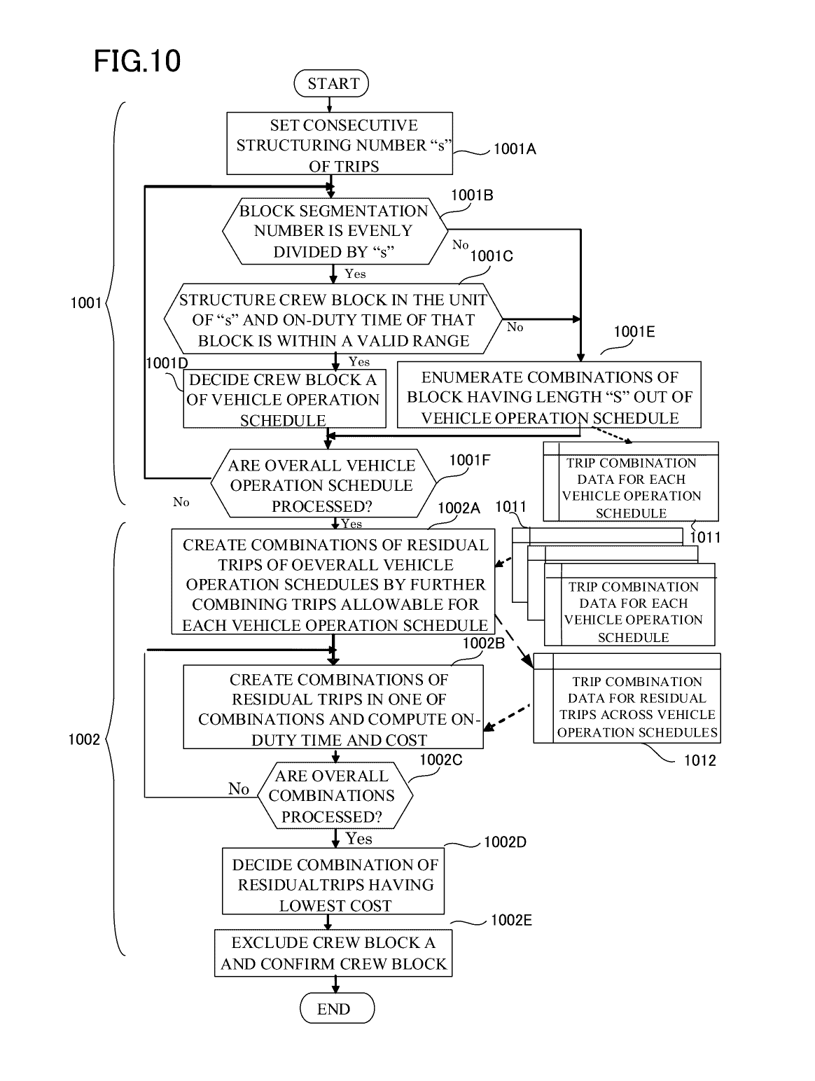

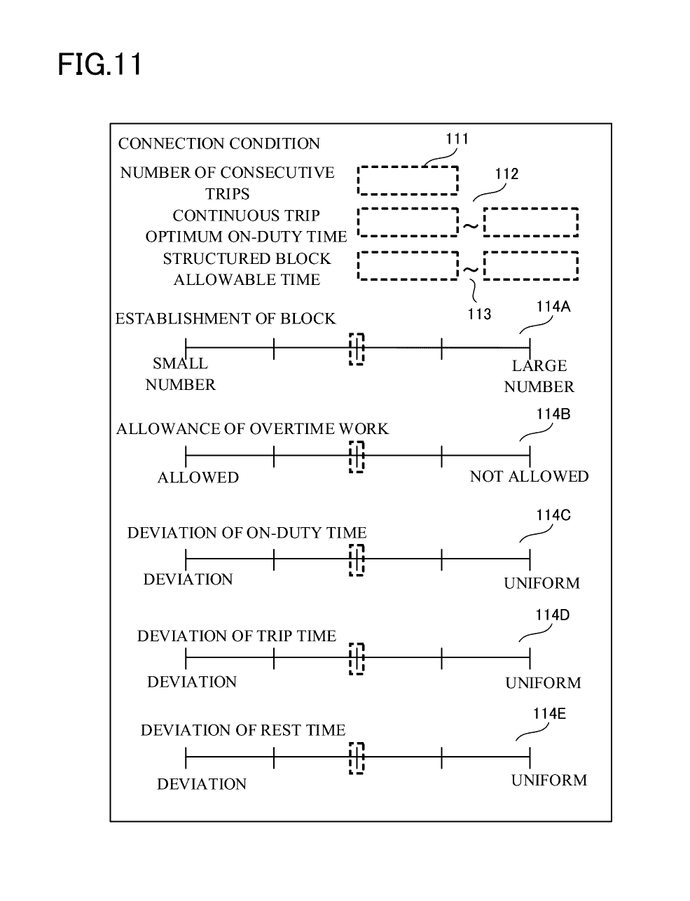

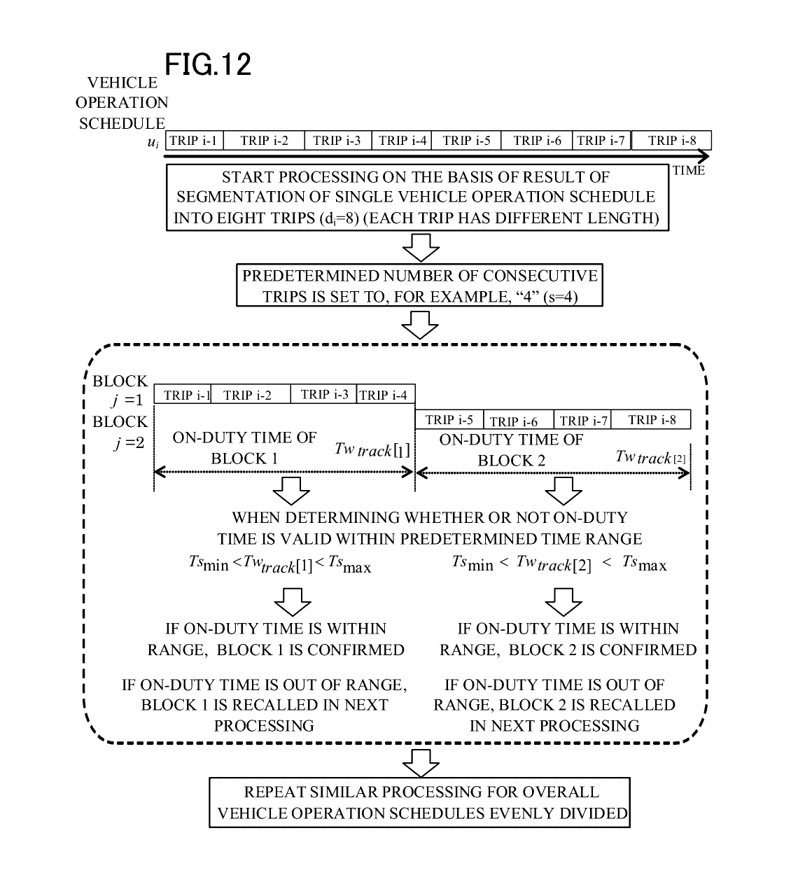

Next, a duty structuring process using the aforementioned duty structuring unit 162 will be described. FIG. 10 is a flowchart illustrating a general processing flow. FIG. 11 illustrates an exemplary setting screen for setting various values used in the processing of the duty structuring unit 162.

This duty structuring process is a process of optimally connecting the trip segments as described above. The optimum connection refers to a process of connecting scattered trip segments on the basis of the vehicle operation schedule in the unit of a predetermined consecutive trip number and finding a sequence having a work time closest to a target work time.

In this description of the duty structuring process, first, an exemplary setting screen of FIG. 11 will be described.

Referring to FIG. 11, a selection box “CONSECUTIVE STRUCTURING NUMBER” 111 is used to input the number of trip segments consecutively connected. If the standard on-duty time is set to eight hours, and the work time is bisected into two four-hour works, the consecutive structuring number becomes “2.”

A selection box “CONTINUOUS TRIP OPTIMUM ON-DUTY TIME” 112 is used to set and input a width (minimum and maximum values) of the allowed on-duty time for determining whether or not a duty is established by connecting the trips in the unit of the consecutive structuring number (also referred to as a “consecutive structuring number”). That is, while the created duty typically does not match the standard on-duty time of eight hours, it is determined whether or not its difference is within an allowable range. If this allowable range is not satisfied, the corresponding combination is not considered as being sui[Table for establishment of the block.

A selection box “STRUCTURED BLOCK ALLOWANCE TIME” 113 allows various combinations of the on-duty times when a combination of trips is created only using residual trips as described below. In this regard, a width of the on-duty time (minimum and maximum values) that is not apparently allowed is set. It is determined that any duty obtained by combining trips that do not satisfy this range is not established.

Deviation setting portions 114A to 114E are used to change or set the coefficient (weight) of the cost computation formula described below to an arbitrary value.

Next, the processing will be described in more detail with reference to the flowchart of FIG. 10.

Process 1001: Pre-Processing for Sole Vehicle Operation Schedule

If a crew member continuously works on the same vehicle, this situation is most efficient. If this situation can be obtained by efficiently combining trip in a vehicle operation schedule, the connection of trips is directly confirmed. Before a description thereof, the vehicle operation schedule is denoted by “ui,” and the number of all present vehicle operation schedules is denoted by “x” (maximum value of “i”).

First, a target number of trips connected consecutively (consecutive structuring number) is set to “s” (step 1001A). As described above, this consecutive structuring number “s” refers to the number of trip segments connected consecutively. If the standard on-duty time is set to eight hours, and the block is bisected into two four-hour works, the consecutive structuring number becomes “2.”

Next, the block segmentation number “d” is divided by the consecutive structuring number “s” (step 1001B). If the segmentation number “d” of the vehicle operation schedule is evenly divided by the consecutive structuring number “s”, that is, if there is no residue as a result of division “di/s,” where “di” denotes the segmentation number of a certain vehicle operation schedule ui, it is determined whether or not the consecutive trips are directly selected in the block (step 1001C).

For this purpose, on the selection box “CONTINUOUS TRIP OPTIMUM ON-DUTY TIME” 112 described in conjunction with FIG. 11, a trip minimum time Tsmin and a trip maximum time Tsmax are suitably defined.

For example, as illustrated in FIG. 12, a vehicle operation schedule ui is segmented into eight trips (di=8), and the consecutive structuring number is set to “4” (s=4). In this case, there is no residue in the block. Therefore, a first half of four trips and a second half of four trips can be created. If each block satisfies the on-duty time requirement (YES in step 1001C), this four trips segmentation is confirmed in the crew block (step 1001D).

That is, as illustrated in FIG. 12, if the vehicle operation schedule ui segmented into eight trips (di=8) is combined by setting the consecutive structuring number to “4” (s=4), a first half of four trips and a second half of four trips (j=1 and j=2) can be created. In this case, by setting an on-duty time of the block (j=1) to Tw_{track{1}} and setting an on-duty time of the block (j=2) to Tw_{track{2}}, it is determined whether or not such an on-duty time is within a predetermined range of the minimum time Tsmin and the maximum time Tsmax. As a result, if the on-duty time is within the aforementioned range, and each block has the on-duty time of a valid range (YES in step 1001C), a crew block is confirmed as four-segment trips (j=1 and j=2) as described above, and the corresponding block are excluded from consideration in the subsequent processing as being decided already.

If the on-duty time is not valid even when there is no residue (NO in step 1001C), the block are not confirmed. In the subsequent processing, the trips are likely to be appropriately processed into a first group of two segments, a second group of four segments, and a third group of two segments.

Next, a processing performed when the segmentation number of the vehicle operation schedule is not evenly divided by the consecutive trip number (NO in step 1001B) and when it is determined that the block are not valid (NO in step 1001C) will be described. In this processing, assuming that a certain vehicle operation schedule “ux” has a segmentation number “dx,” a computation “dx/s” may result in a residue. In this case, validity of the consecutive trips is determined, and a pattern of the residual trips is analyzed.

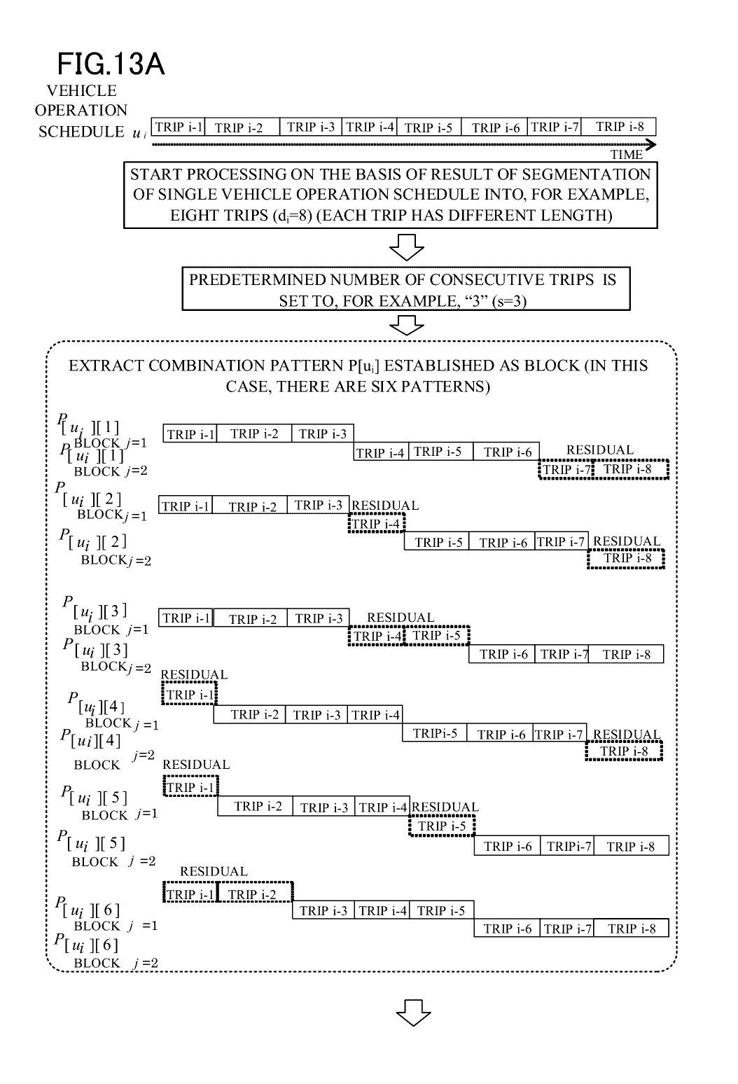

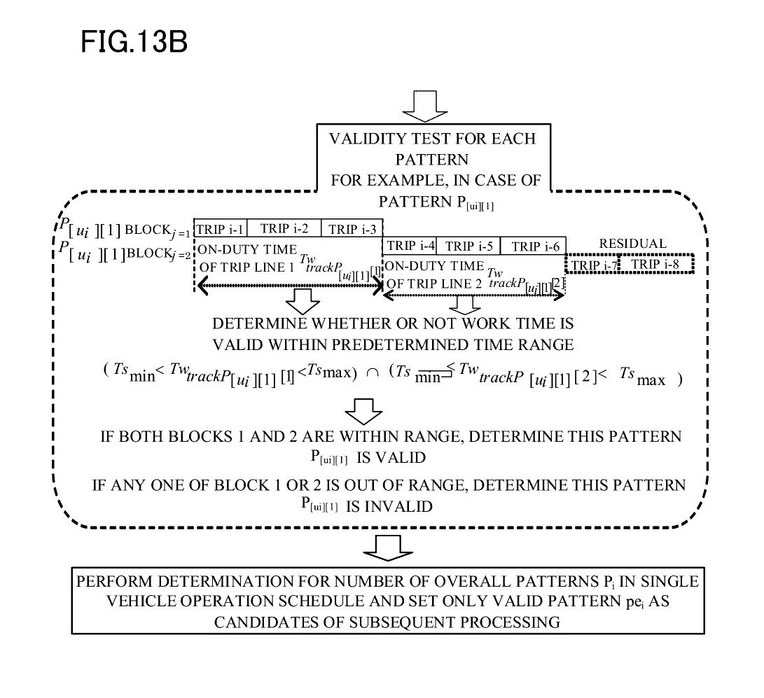

For example, as illustrated in FIG. 13A, assuming that a vehicle operation schedule “ui” is segmented into eight trips (di=8), and the consecutive structuring number is set to “3” (s=3), residual trips are generated as a result of combination. In this case (NO in step 1001B), if the structuring is not optimum even without a residue as a result of the aforementioned processing (NO in step 1001C), the following processing is executed.

In the vehicle operation schedule “ui,” the block are combined by a predetermined consecutive structuring number “s,” and all patterns P_{[ui]} where any residual trip is generated are enumerated as illustrated in FIG. 13A (step 1001E). Even for the consecutive trips (j=1 and j=2) generated in this case, it is determined whether or not such on-duty times Tw_{trackP[ui]{1}[1]} and Tw_{trackP[ui]{1}[2]} are within a predetermined range of the minimum time Tsmin and the maximum time Tsmax as illustrated in FIG. 13B. If any block (j=1 or j=2) is out of the range, the corresponding pattern P_{[ui][1]} is regarded as being invalid.

That is, for a single vehicle operation schedule, determination is performed by the number of all patterns “pi”, and only valid patterns “pei” are selected as candidates of the subsequent processing. For example, in the example of FIG. 13A, it is assumed that the number of patterns is set to “6” (pi=6), and there are patterns P_{[ui][1]} to P_{[ui][6]}. If it is determined that the patterns P_{[ui][4]} and P_{[ui][5]} are invalid, four patterns P_{[ui][1]}, P_{[ui][2]}, P_{[ui]3]}, and P_{[ui][6]} (pei=4) are valid out of the vehicle operation schedule “ui.”

By excluding invalid patterns as being inappropriate in this manner, some patterns of a series of trips and a combination of residual trips can be determined for each vehicle operation schedule. These patterns are created as trip combination data 1011 for each vehicle operation schedule.

Through the aforementioned processing, valid patterns are found for a single vehicle operation schedule. Accordingly, the same processing is repeated for all of the vehicle operation schedules (step 1001F), so that valid residual trip generation patterns are found for each vehicle operation schedule as described below.

[Math. 3]

A valid pattern matrix for a certain vehicle operation schedule u, is obtained as follows.

(P_{[u}_{ᵢ}_{][1]}, P_{[u}_{ᵢ}_{][2]}, P_{[u}_{ᵢ}_{][3]} . . . P_{[u}_{ᵢ}_{][pe}_{ᵢ}_{]})

The same processing is repeated for all vehicle operation schedule x to find valid patterns.

$$( \begin{matrix}{P}_{[ {u}_{1} ] [ 1 ]} & , & {P}_{[ {u}_{1} ] [ 2 ]} & , & {P}_{[ {u}_{1} ] [ 3 ]} & ⋯ & {P}_{[ {u}_{1} ] [ {pe}_{1} ]} \\ {P}_{[ {u}_{2} ] [ 1 ]} & , & {P}_{[ {u}_{2} ] [ 2 ]} & , & {P}_{[ {u}_{2} ] [ 3 ]} & ⋯ & {P}_{[ {u}_{2} ] [ {Pe}_{2} ]} \\ & & & : & & & \\ {P}_{[ {u}_{x} ] [ 1 ]} & , & {P}_{[ {u}_{x} ] [ 2 ]} & , & {P}_{[ {u}_{x} ] [ 3 ]} & ⋯ & {P}_{[ {u}_{x} ] [ {Pe}_{x} ]}\end{matrix} )$$

The number of rows and the number of columns can be changed depending on validity determination.

Process 1002: Combine Residual Trips Across Overall Vehicle Operation Schedules

In this process, combinations of only residual trips are created across overall vehicle operation schedules on the basis of the patterns determined for each vehicle operation schedule. That is, only residual trips are structured depending on a predetermined consecutive structuring number “s.” Data are created by combining all of the structured residual trips using patterns of overall vehicle operation schedules, and the trips are reviewed. Costs are computed to find only a combination of residual trips having the shortest on-duty time out of combinations across overall vehicle operation schedules, and a combination having the lowest parameter value is confirmed as an optimum combination, and data are created as a crew block. This will be described below in more detail.

Combinations of overall vehicle operation schedules are created using patterns of each vehicle operation schedule (step 1002A). It is assumed that there are four vehicle operation schedules ui (x=4), and the number of valid patterns is set for each vehicle operation schedule as follows. In this case, a product obtained by multiplying the numbers of valid patterns of each vehicle operation schedule becomes the number of combinations.

For valid patterns P_{[u1]} of a vehicle operation schedule ul, its maximum number is set to “2” (pel=2).

For valid patterns P_{[u2]} of a vehicle operation schedule u2, its maximum number is set to “3” (pel=3).

For valid patterns P_{[u3]} of a vehicle operation schedule u3, its maximum number is set to “4” (pel=4).

For valid patterns P_{[u4]} of a vehicle operation schedule u4, its maximum number is set to “1” (pel=1).

As a result, the following matrix can be obtained.

$$( \begin{matrix}{P}_{[ {u}_{1} ] [ 1 ]} & , & {P}_{[ {u}_{1} ] [ 2 ]} & & & & \\ {P}_{[ {u}_{2} ] [ 1 ]} & , & {P}_{[ {u}_{2} ] [ 2 ]} & , & {P}_{[ {u}_{2} ] [ 3 ]} & & \\ {P}_{[ {u}_{3} ] [ 1 ]} & , & {P}_{[ {u}_{3} ] [ 2 ]} & , & {P}_{[ {u}_{3} ] [ 3 ]} & , & {P}_{[ {u}_{3} ] [ 4 ]} \\ {P}_{[ {u}_{4} ] [ 1 ]} & & & & & & \end{matrix} ) \qquad [ Math . 4 ]$$

In this case, assuming that a combination of valid patterns across the vehicle operation schedules is denoted by “Q[n],” and the number of the combinations is denoted by “n,” twenty four combinations (n=24) can be obtained as follows.

TABLE 8

Q_{[1]} = P_{[u}_{₁}_{][1]} × P_{[u}_{₂}_{][1]} × P_{[u}_{₃}_{][1]} × P_{[u}_{₄}_{][1]}
Q_{[2]} = P_{[u}_{₁}_{][1]} × P_{[u}_{₂}_{][1]} × P_{[u}_{₃}_{][2]} × P_{[u}_{₄}_{][1]}
Q_{[3]} = P_{[u}_{₁}_{][1]} × P_{[u}_{₂}_{][1]} × P_{[u}_{₃}_{][3]} × P_{[u}_{₄}_{][1]}
Q_{[4]} = P_{[u}_{₁}_{][1]} × P_{[u}_{₂}_{][1]} × P_{[u}_{₃}_{][4]} × P_{[u}_{₄}_{][1]}
Q_{[5]} = P_{[u}_{₁}_{][1]} × P_{[u}_{₂}_{][2]} × P_{[u}_{₃}_{][1]} × P_{[u}_{₄}_{][1]}
Q_{[6]} = P_{[u}_{₁}_{][1]} × P_{[u}_{₂}_{][2]} × P_{[u}_{₃}_{][2]} × P_{[u}_{₄}_{][1]}
Q_{[7]} = P_{[u}_{₁}_{][1]} × P_{[u}_{₂}_{][2]} × P_{[u}_{₃}_{][3]} × P_{[u}_{₄}_{][1]}
Q_{[8]} = P_{[u}_{₁}_{][1]} × P_{[u}_{₂}_{][2]} × P_{[u}_{₃}_{][4]} × P_{[u}_{₄}_{][1]}
Q_{[9]} = P_{[u}_{₁}_{][1]} × P_{[u}_{₂}_{][3]} × P_{[u}_{₃}_{][1]} × P_{[u}_{₄}_{][1]}
Q_{[10]} = P_{[u}_{₁}_{][1]} × P_{[u}_{₂}_{][3]} × P_{[u}_{₃}_{][2]} × P_{[u}_{₄}_{][1]}
Q_{[11]} = P_{[u}_{₁}_{][1]} × P_{[u}_{₂}_{][3]} × P_{[u}_{₃}_{][3]} × P_{[u}_{₄}_{][1]}
Q_{[12]} = P_{[u}_{₁}_{][1]} × P_{[u}_{₂}_{][3]} × P_{[u}_{₃}_{][4]} × P_{[u}_{₄}_{][1]}
Q_{[13]} = P_{[u}_{₁}_{][2]} × P_{[u}_{₂}_{][1]} × P_{[u}_{₃}_{][1]} × P_{[u}_{₄}_{][1]}
Q_{[14]} = P_{[u}_{₁}_{][2]} × P_{[u}_{₂}_{][1]} × P_{[u}_{₃}_{][2]} × P_{[u}_{₄}_{][1]}
Q_{[15]} = P_{[u}_{₁}_{][2]} × P_{[u}_{₂}_{][1]} × P_{[u}_{₃}_{][3]} × P_{[u}_{₄}_{][1]}
Q_{[16]} = P_{[u}_{₁}_{][2]} × P_{[u}_{₂}_{][1]} × P_{[u}_{₃}_{][4]} × P_{[u}_{₄}_{][1]}
Q_{[17]} = P_{[u}_{₁}_{][2]} × P_{[u}_{₂}_{][2]} × P_{[u}_{₃}_{][1]} × P_{[u}_{₄}_{][1]}
Q_{[18]} = P_{[u}_{₁}_{][2]} × P_{[u}_{₂}_{][2]} × P_{[u}_{₃}_{][2]} × P_{[u}_{₄}_{][1]}
Q_{[19]} = P_{[u}_{₁}_{][2]} × P_{[u}_{₂}_{][2]} × P_{[u}_{₃}_{][3]} × P_{[u}_{₄}_{][1]}
Q_{[20]} = P_{[u}_{₁}_{][2]} × P_{[u}_{₂}_{][2]} × P_{[u}_{₃}_{][4]} × P_{[u}_{₄}_{][1]}
Q_{[21]} = P_{[u}_{₁}_{][2]} × P_{[u}_{₂}_{][3]} × P_{[u}_{₃}_{][1]} × P_{[u}_{₄}_{][1]}
Q_{[22]} = P_{[u}_{₁}_{][2]} × P_{[u}_{₂}_{][3]} × P_{[u}_{₃}_{][2]} × P_{[u}_{₄}_{][1]}
Q_{[23]} = P_{[u}_{₁}_{][2]} × P_{[u}_{₂}_{][3]} × P_{[u}_{₃}_{][3]} × P_{[u}_{₄}_{][1]}
Q_{[24]} = P_{[u}_{₁}_{][2]} × P_{[u}_{₂}_{][3]} × P_{[u}_{₃}_{][4]} × P_{[u}_{₄}_{][1]}

Then, possible combinations of residual trips for a certain pattern in the unit of a predetermined consecutive structuring number “s” are enumerated.

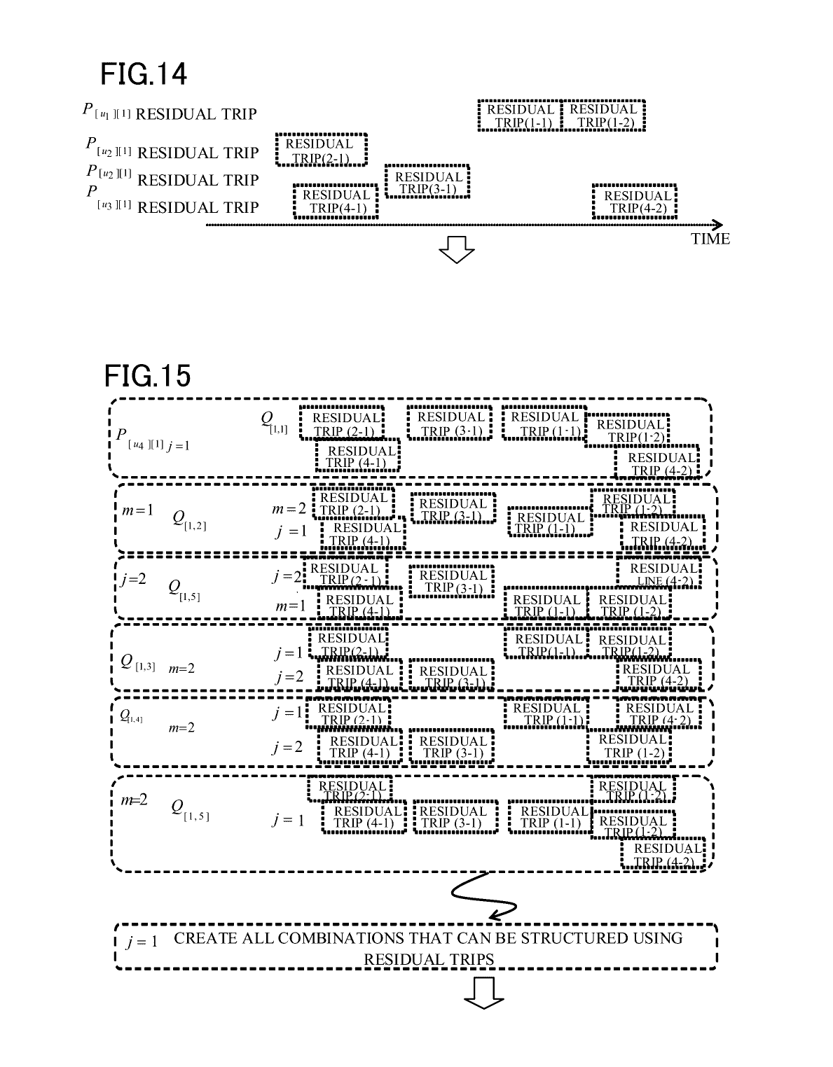

For example, assuming that a single pattern is selected out of combinations of four vehicle operation schedules, and the predetermined consecutive structuring number is set to “3” (s=3), a distribution of the residual trips in this case is illustrated in FIG. 14, and patterns that can be combined are illustrated in FIG. 15.

That is, FIG. 14 shows a distribution of residual trips extracted from one of overall combinations Q_{[1]} in each pattern.

Q_{[1]}=P_{[u}_{₁}_{][1]}×P_{[u}_{₂}_{][1]}×P_{[u}_{₃}_{][1]}×P_{[u}_{₄}_{][1]} [Math. 5]

FIG. 15 illustrates combinations of trips obtained by structuring residual trips of each pattern of the distribution of FIG. 14 in the unit of predetermined consecutive structuring number “s.” In FIG. 15, “y” denotes the number of combinations of residual trips, “Q[n, y]” denotes a combinational matrix, “m” denotes the number of established trips, and “j” denotes a sequence number of each block established in the combination. Whether or not such a block can be established is analyzed for overall possible combinations of residual trips.

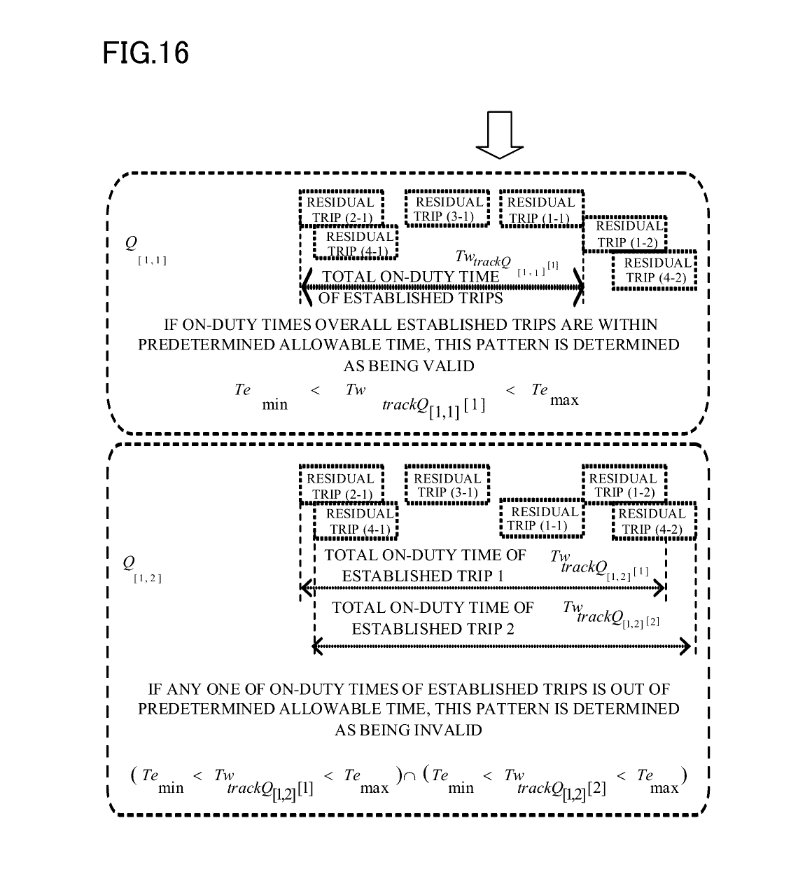

Then, as illustrated in FIG. 16, every single combination is analyzed to determine whether it is valid or invalid.

In the example of the combination Q_{[1, 1]}, residual trips (2-1), (3-1), and (1-1) are established. A total on-duty time of these established block is denoted by “Tw_{trackQ[1,1]}[1].” A minimum time Temin and a maximum time Temax are defined for the allowable structured trips. If an on-duty time of overall established block is within a predetermined allowable time as described below, this pattern is valid.

Teₘᵢₙ<T_{trackQ}_{_{[1,1]}}_{[1]}<Teₘₐₓ [Math. 6]

In the example of the combination Q_{[1, 1]}, a combination of the established residual trips (2-1), (3-1), and (1-1) satisfies the aforementioned conditional equation, and thus, it is determined that this pattern is valid.

Referring to FIG. 16 again, in the example of the combination Q_{[1, 2]}, a combination of residual trips (2-1), (3-1), and (1-2) and a combination of residual trips (4-1), (1-1), and (4-2) are established. However, both the total on-duty times Tw_{trackQ[1,2]}[1] and Tw_{trackQ[1,2]}[2] exceed an allowable time of the structured trips. That is, the following conditional equation is not satisfied. If any one of the on-duty times of the trips established in this manner exceeds a predetermined allowable time, this pattern is determined as being invalid.

(Teₘᵢₙ<Tw_{trackQ}_{_{[1, 2]}}_{[1]}<Teₘₐₓ)∩(Teₘᵢₙ<Tw_{trackQ}_{_{[1,2]}}_{[2]}<Teₘₐₓ) [Math. 7]

For twenty four combinations of trips Q_{[n]} described above (n=24), focusing on only combinations 1 to 6, the combinations Q_{[1, 2]}, Q_{[1, 3]}, Q_{[1, 4]}, and Q_{[1, 5]} are determined as being invalid.

Alternatively, instead of comparison between the total on-duty time of the aforementioned combination of trips and the allowable time of the structured trips, overlapping trips in the combined crew block may be excluded from the start because a relief of the crew member is not possible in that case.

Then, costs are computed for overall combinations of the residual trips determined as being valid (steps 1002B and 1002C). For this purpose, various values of the combined pattern are computed.

First, a trip time of the trips established in a certain combination is calculated.

TABLE 9

| | |
|---|---|
| trip time, where “j” denotes a block | Tr_{Q}_{_{[n][y]}}_{[j][i]} |
| established in a certain combination Q_{[n, y]}, | |
| and “i” denotes an order of the trip in | |
| the established block | |
| trip start timing of the first trip in the | Tr_{startQ}_{_{[n][y]}}_{[j][1]} |
| established block, where “j” denotes a | |
| block established in a certain | |
| combination Q_{[n, y]} | |
| trip end timing, where “j” denotes a | Tr_{endQ}_{_{[n][y]}}_{[j][s]} |
| block established in a certain | |
| combination Q_{[n, y]}, and “s” denotes a | |
| latest order of the trip (maximum value) | |
| in the established block | |

Using the values described above, an on-duty time of the block established in a certain combination is calculated.

TABLE 10

| | |
|---|---|
| on-duty time of a | Tw_{trackQ}_{_{[n][y]}}_{[j]} = Tr_{endQ}_{_{[n][y]}}_{[j][s]} - |
| block j established in | Tr_{StartQ}_{_{[n][y]}}_{[j][1]} |
| a certain combination | |
| Q_{[n, y]} | |
| trip time of a block j | Tr_{trackQ}_{_{[n][y]}}_{[j]} = Σᵢ₌₁^{s} Tr_{Q}_{_{[n][y]}}_{[j][i]} |
| established in a | |
| certain combination | |
| Q_{[n, y]} | |
| rest time of a block j | Tb_{trackQ}_{_{[m][y]}}_{[j]} = Tw_{trackQ}_{_{[n][y]}}_{[j]} - |
| established in a | Tr_{trackQ}_{_{[n][y]}}_{[j]} |
| certain combination | |
| Q_{[n, y} | |

A total number of block established in a certain combination is calculated.

TABLE 11

| | |
|---|---|
| number of | e_{Q}_{_{[n][y]}} |
| established | |
| block | |
| total on-duty time of overall block established in a certain combination Q_{[n, y]} | $\begin{matrix}{Tw}_{{runQ}_{[ n ] [ y ]}} = {\sum }_{j = 1}^{{e}_{{Q}_{[ n ] [ y ]}}} {Tw}_{{trackQ}_{[ n ] [ y ]} [ j ]} = \\ {\sum }_{j = 1}^{{e}_{{Q}_{[ n ] [ y ]}}} ( {Tr}_{{endQ}_{[ n ] [ y ]} [ j ] [ s ]} - {Tr}_{{startQ}_{[ n ] [ y ]} [ j ] [ 1 ]} )\end{matrix}$ |
| total trip time of overall block established in a certain combination Q_{[n, y]} | $\begin{matrix}{Tr}_{{runQ}_{[ n ] [ y ]}} = {\sum }_{j = 1}^{{e}_{{Q}_{[ n ] [ y ]}}} {Tr}_{{trackQ}_{[ n ] [ y ]} [ j ]} = \\ {\sum }_{j = 1}^{{e}_{{Q}_{[ n ] [ y ]}}} {\sum }_{i = 1}^{s} {Tr}_{{Q}_{[ n ] [ y ]} [ j ] [ i ]}\end{matrix}$ |
| total rest time of overall block established in a certain combination Q_{[n, y]} | $\begin{matrix}{Tb}_{{runQ}_{[ n ] [ y ]}} = {\sum }_{j = 1}^{{e}_{{Q}_{[ n ] [ y ]}}} {Tb}_{{trackQ}_{[ n ] [ y ]} [ j ]} = {\sum }_{j = 1}^{{e}_{{Q}_{[ n ] [ y ]}}} \\ ( ( {Tr}_{{endQ}_{[ n ] [ y ]} [ j ] [ s ]} - {Tr}_{{startQ}_{[ n ] [ y ]} [ j ] [ 1 ]} ) - {\sum }_{i = 1}^{s} {Tr}_{{Q}_{[ n ] [ y ]} [ j ] [ i ]} )\end{matrix}$ |

An average on-duty time of the block established in a certain combination is calculated.

TABLE 12

| | |
|---|---|
| average on-duty time of block established in a certain combination Q_{[n,y]} | ${Tw}_{{avQ}_{[ n , y ]}} = \frac{{Tw}_{{runQ}_{[ n , y ]}}}{{e}_{{Q}_{[ n ] [ y ]}}} = \frac{{\sum }_{j = 1}^{{e}_{{Q}_{[ n ] [ y ]}}} {Tw}_{{trackQ}_{[ n , y ]} [ j ]}}{{e}_{{Q}_{[ n ] [ y ]}}} = \frac{{\sum }_{j = 1}^{{e}_{{Q}_{[ n ] [ y ]}}} ( {Tr}_{{endQ}_{[ n , y ]} [ j ] [ n ]} - {Tr}_{{startQ}_{[ n , y ]} [ j ] [ 1 ]} )}{{e}_{{Q}_{[ n ] [ y ]}}}$ |
| average trip time of block established in a certain combination Q_{[n, y]} | ${Tr}_{{avQ}_{[ n , y ]}} = \frac{{Tr}_{{runQ}_{[ n , y ]}}}{{e}_{{Q}_{[ n ] [ y ]}}} = \frac{{\sum }_{j = 1}^{{e}_{{Q}_{[ n ] [ y ]}}} {Tr}_{{trackQ}_{[ n , y ]} [ j ]}}{{e}_{{Q}_{[ n ] [ y ]}}} = \frac{{\sum }_{j = 1}^{{e}_{{Q}_{[ n ] [ y ]}}} {\sum }_{i = 1}^{s} {Tr}_{{Q}_{[ n , y ]} [ j ] [ i ]}}{{e}_{{Q}_{[ n ] [ y ]}}}$ |
| average rest time of block established in a certain combination Q_{[n, y]} | ${Tb}_{{avQ}_{[ n , y ]}} = \frac{{Tb}_{{runQ}_{[ n , y ]}}}{{e}_{{Q}_{[ n ] [ y ]}}} = \frac{{\sum }_{j = 1}^{{e}_{{Q}_{[ n ] [ y ]}}} {Tb}_{{trackQ}_{[ n , y ]} [ j ]}}{{e}_{{Q}_{[ n ] [ y ]}}} = \\ \frac{{\sum }_{j = 1}^{{e}_{{Q}_{[ n ] [ y ]}}} \begin{matrix}( ( {Tr}_{{endQ}_{[ n , y ]} [ j ] [ n ]} - {Tr}_{{startQ}_{[ n , y ]} [ j ] [ 1 ]} ) - \\ {\sum }_{i = 1}^{s} {Tr}_{{Q}_{[ n , y ]} [ j ] [ i ]} )\end{matrix}}{{e}_{{Q}_{[ n ] [ y ]}}}$ |

A variance of the on-duty time of the block established in a certain combination is calculated.

TABLE 13

| | |
|---|---|
| variance of work time of block established in a certain combination Q_{[n, y]} | ${Tw}_{{δ}^{2} {Q}_{[ n , y ]}} = \frac{1}{{e}_{{Q}_{[ n , y ]}}} {\sum }_{j = 1}^{{e}_{{Q}_{[ n ] [ y ]}}} {( {Tw}_{{avQ}_{[ n , y ]}} - {Tw}_{{trackQ}_{[ n , y ]} [ j ]} )}^{2}$ |
| variance of trip time of block established in a certain combination Q_{[n, y]} | ${Tr}_{{δ}^{2} {Q}_{[ n , y ]}} = \frac{1}{{e}_{{Q}_{[ n , y ]}}} {\sum }_{j = 1}^{{e}_{{Q}_{[ n ] [ y ]}}} {( {Tr}_{{avQ}_{[ n , y ]}} - {Tr}_{{trackQ}_{[ n , y ]} [ j ]} )}^{2}$ |
| variance of rest time of block established in a certain combination Q_{[n, y]} | ${Tb}_{{δ}^{2} {Q}_{[ n , y ]}} = \frac{1}{{e}_{{Q}_{[ n , y ]}}} {\sum }_{j = 1}^{{e}_{{Q}_{[ n ] [ y ]}}} {( {Tb}_{{avQ}_{[ n , y ]}} - {Tb}_{{trackQ}_{[ n , y ]} [ j ]} )}^{2}$ |

Costs are calculated for a certain combination.

TABLE 14

| | |
|---|---|
| cost of block established in a certain combination C_{eQ}_{_{[n, y]}} (cost parameter = V₁) | ${C}_{{eQ}_{[ n , y ]}} = {V}_{1} \times \frac{1}{{e}_{{Q}_{[ n , y ]}}}$ |
| cost of on-duty time of a certain | C_{tQ}_{_{[n, y]}} = V₂ × Tw_{avQ}_{_{[n, y]}} |
| combination C_{tQ}_{_{[n, y]}} | |
| (cost parameter = V₂) | |
| cost of on-duty time deviation of a | C_{wQ}_{_{[n, y]}} = V₃ × Tw_{δ}_{²}_{Q}_{_{[n, y]}} |
| certain combination C_{wQ}_{_{[n, y]}} | |
| (cost parameter = V₃) | |
| cost of trip time deviation of a certain | C_{rQ}_{_{[n, y]}} = V₄ × Tr_{δ}_{²}_{Q}_{_{[n, y]}} |
| combination C_{rQ}_{_{[n, y]}} | |
| (cost parameter = V₄) | |
| cost of rest time deviation of a certain | C_{bQ}_{_{[n, y]}} = V₅ × Tb_{δ}_{²}_{Q}_{^{[n, y]}} |
| combination C_{bQ}_{_{[n, y]}} | |
| (cost parameter = V₅) | |

General determination parameters of a certain combination

TABLE 15

| | |
|---|---|
| total cost value of a certain | C_{RunQ}_{_{[n, y]}} = C_{eQ}_{_{[n, y]}} + |
| combination C_{RunQ}_{_{[n, y]}} | C_{tQ}_{_{[n, y]}} + C_{wQ}_{_{[n, y]}} + |
| | C_{rQ}_{_{[n, y]}} + C_{bQ}_{_{[n, y]}} |

Various values of overall patterns are computed in this manner. A combination having the lowest total cost is confirmed as a crew block (steps 1002D and 1002E). That is, as described below, the minimum value corresponds to optimum block segmentation.

TABLE 16

| | |
|---|---|
| minimum cost value Cₒₚₜ | Cₒₚₜ = min [symbol] |
| optimum trip combination | |
| number nₒₚₜ, yₒₚₜ | |

Next, examples will be described.

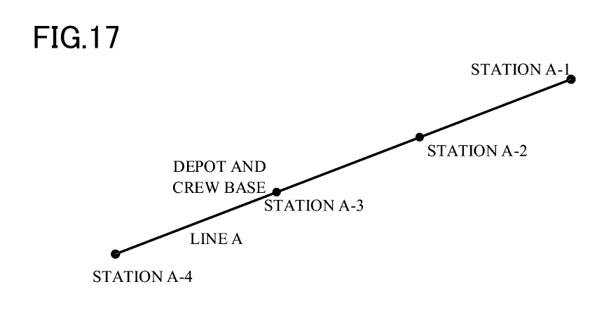

It is assumed that a train is scheduled to travel along a route of FIG. 17, a base or a standby room for crew members is located in Station A-3, and a deadheading station of train operation schedule is Station A-3. Accordingly, a crew member starts a trip from Station A-3 and returns to Station A-3 at the end of the trip.

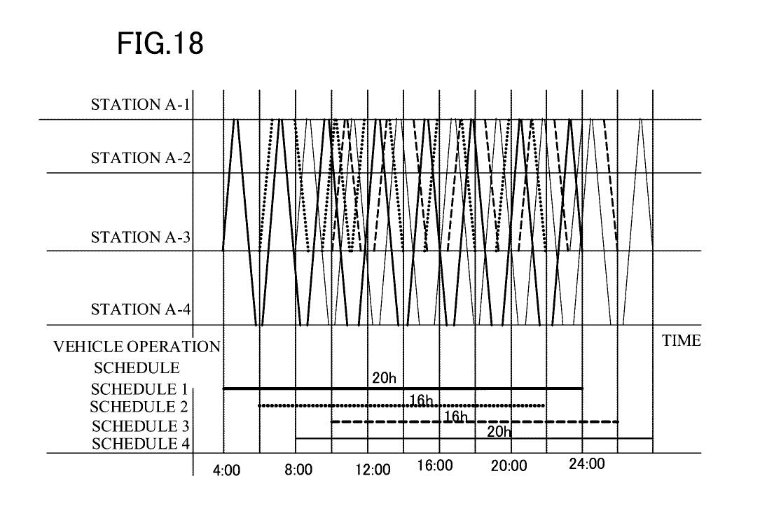

A scheduling diagram of FIG. 18 is created for this train. Four vehicle operation schedules obtained from the crated scheduling diagram include two 20-hour trips and two 16-hour trips. The most efficient crew scheduling is obtained on the basis of the scheduling diagram and the vehicle operation schedule.

In this example, a vehicle operation schedule is roughly segmented into four-hour trips, and two four-hour trip segments are combined to create an eight-hour crew duty.

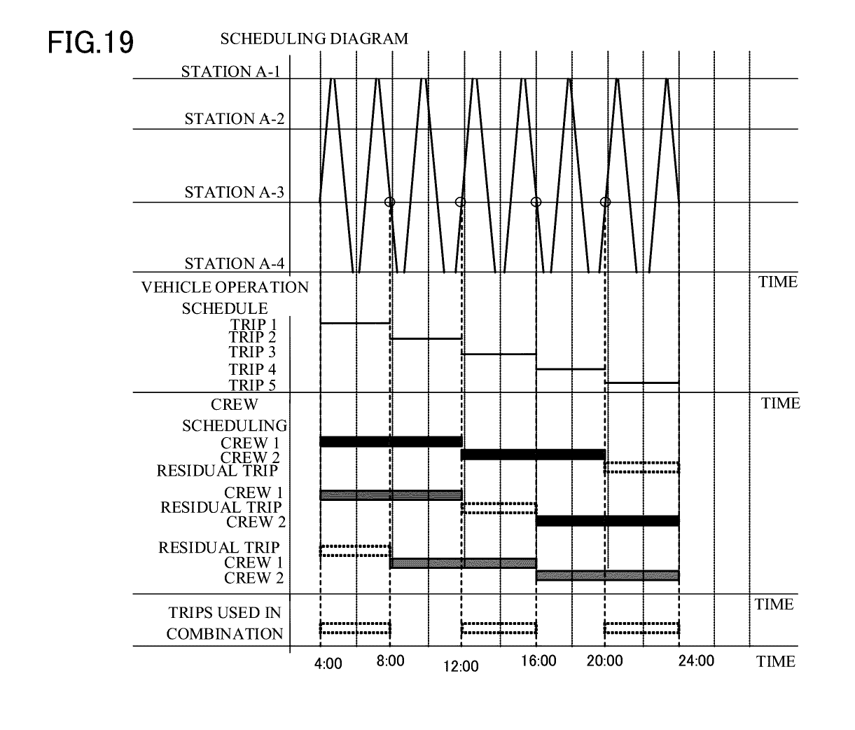

First, a vehicle operation schedule 1 segmented into trips will be described with reference to FIG. 19. As illustrated in FIG. 19, the vehicle operation schedule 1 is roughly segmented in the unit of four hours. If it is assumed that a crew member relief can be performed only at Station A-3, and crew members relief at the timing of train arrival, the circles of FIG. 18 indicate relief allowable timings. In this case, a 20-hour trip can be roughly segmented into five 4-hour trips. Three crew members are necessary to operate five 4-hour trips, including two crew members for an 8-hour duty and one crew member for a 4-hour duty. In these duty, there are three patterns of the crew scheduling as illustrated in FIG. 19. That is, out of five trips, three trips may remain as residual trips.

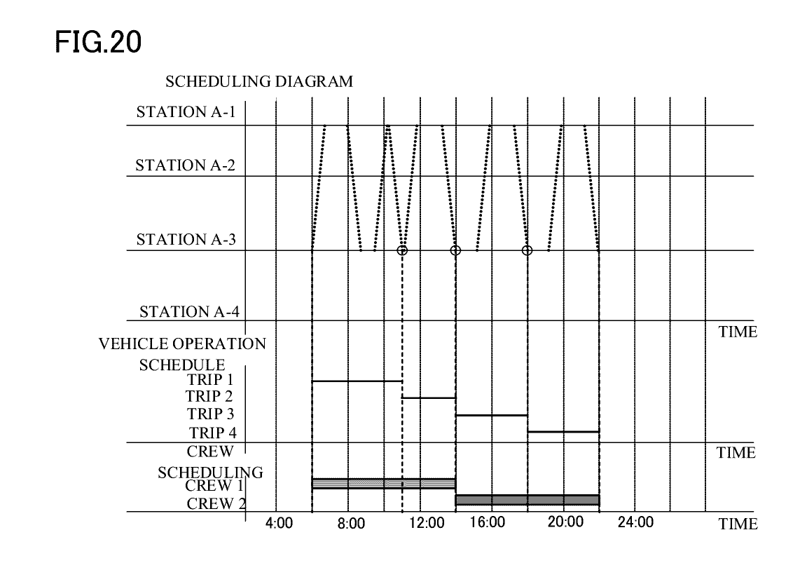

Next, a case where the vehicle operation schedule 2 is segmented into trips will be described with reference to FIG. 20. As illustrated in FIG. 20, the vehicle operation schedule 2 is roughly segmented in the unit of four hours. It is assumed that a station where a relief can be performed is only Station A-3, and the relief is performed when a train arrives. The circles indicate timings at which a relief can be performed. In this case, an operation of sixteen hours can be roughly segmented into four 4-hour trips. For scheduling four 4-hour trips, exactly two crew members are necessary, and two crew members are sufficient to perform two 8-hour duty. In this case, crew members are most efficiently scheduled, and there is no need to combine other trips. The crew block are optimally structured by rostering two crew members 1 and 2 in FIG. 20.

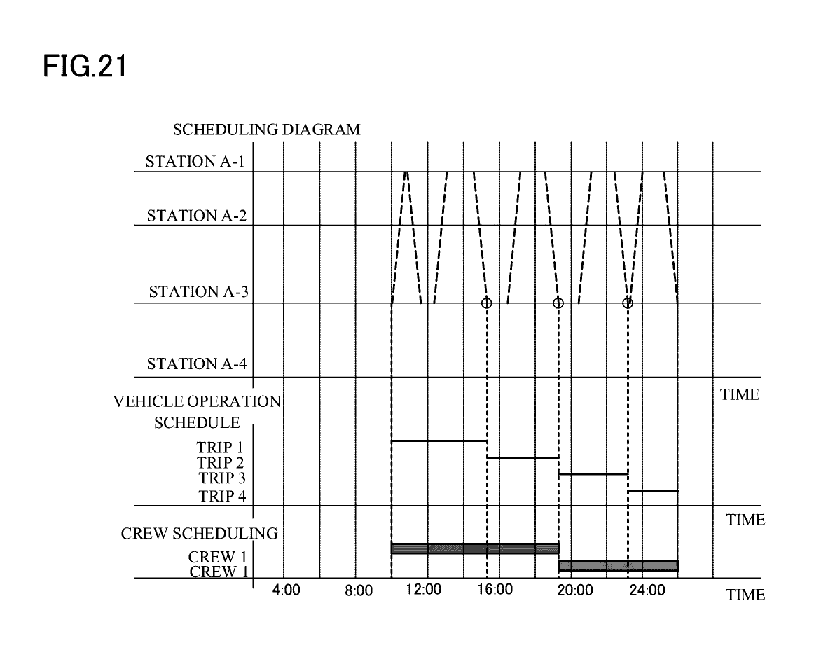

Next, a case where the vehicle operation schedule 3 is segmented into trips will be described with reference to FIG. 21. As illustrated in FIG. 21, the vehicle operation schedule 3 is also similar to the vehicle operation schedule 2 in terms of conditions. Depending on a transit timing, there may be a deviation instead of an exact four-hour trip. However, whether or not a vehicle operation schedule can be exactly evenly segmented depends on a scheduling diagram. Therefore, how much deviation is allowable is determined A crew block may be confirmed if a deviation is within an allowable range. If a deviation is not within an allowable range, similar to the vehicle operation schedule 1, a possibility of generating a residual trip may be detected.

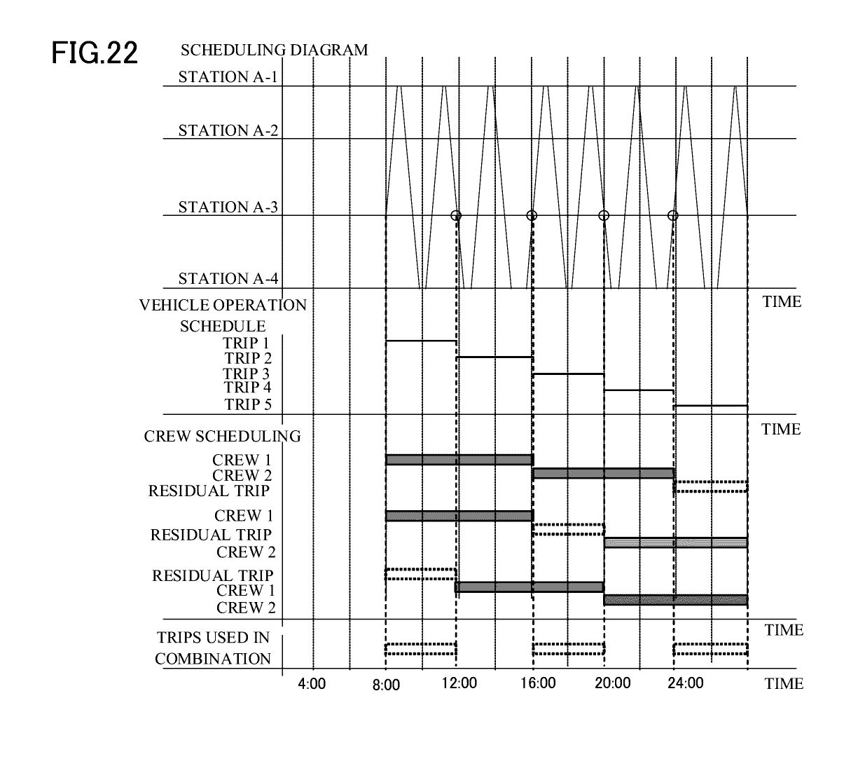

Next, a case where the vehicle operation schedule 4 is segmented into trips will be described with reference to FIG. 22. As illustrated in FIG. 22, the vehicle operation schedule 4 is similar to the vehicle operation schedule 1 in terms of conditions. That is, similarly, the vehicle operation schedule 4 can be roughly segmented in the unit of four hours. It is assumed that a station where a relief can be performed is only Station A-3, and the relief is performed when a train arrives. The circles indicate timings at which a relief can be performed. In this case, a 20-hour trip can be roughly segmented into five 4-hour trips. Three crew members are necessary to operate five 4-hour trips, including two crew members for an 8-hour duty and one crew member for a 4-hour duty. Therefore, there are three patterns of the crew scheduling. Out of five trips, three trips may remain as residual trips.

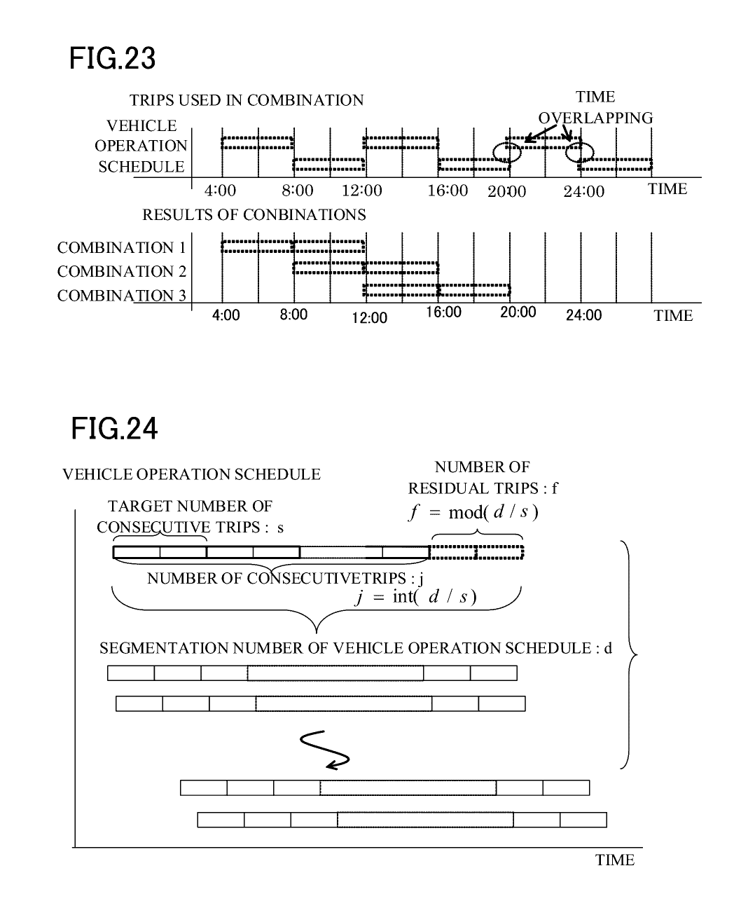

Then, only the residual trips are reviewed. Through the processing described above, block segmentation is performed, and places where residual trip is generated can be specified. Then, possible combinations of residual trips are enumerated. In the example described above, residual trip is generated in the vehicle operation schedules 1 and 4. In this regard, the residual trips that may be generated from the vehicle operation schedules 1 and 4 are combined as illustrated in FIG. 23. The residual trips that may be generated from vehicle operation schedules 1 and 4 are distributed as illustrated in FIG. 23A. The circles in FIG. 23A indicate overlapping time zones where duty are not valid. Therefore, combinations of these overlapping trips are excluded. The residual trips generated from vehicle operation schedules 1 and 4 are roughly four hours. Therefore, for a duty of about eight hours, two residual trips may be structured in a duty. That is, the structuring is performed by setting the consecutive structuring number “s” to “2” (s=2). As a result, three combinations are generated as illustrated in FIG. 23B. One of the three combinations having the lowest cost, for example, having the shortest duty time is decided as an optimum block structure.

Then, a computation number is verified in the example describe above. This example can be generalized as illustrated in FIG. 24. In order to enumerate overall combinations of trips and compute an optimum combination, a computation number in the case of a round robin computation is denoted by “Nall.” Assuming that combinations are arranged by a target number for continuously connecting overall possible trip segments, the following combination formula can be obtained. That is, the computation number Nall in a round robin manner can be obtained using the following equation.

$${N}_{all} {=}_{( d \times {x}_{all} )} {C}_{s} = \frac{( d \times {x}_{all} ) !}{( d \times {x}_{all} - s ) ! \times s !} \qquad [ Math . 8 ]$$

If this is applied to the example described above, the number of combinations “Nall” of the trips of the example can be obtained using the following equation.

$${N}_{all} {=}_{18} {C}_{2} = \frac{18 !}{16 ! \times 2 !} = 153 \qquad [ Math . 9 ]$$

That is, if the example is computed in a round robin manner, it is necessary to compute a total of 153 patterns.

In contrast, according to the embodiment described above, the computation is performed only for combinations of residual trips. A computation number in the case where only residual trips are computed will be denoted by “Nopt”

First, the number of patterns of residual trips generated from the vehicle operation schedule 1 is obtained. The number of combinations “d” of residual trips in the single vehicle operation schedule can be obtained using the following equation.

$$d = \frac{( j + f ) !}{j ! \times f !} \qquad [ Math . 10 ]$$

Then, the number of combinations Nopt of overall trips is obtained using the following equation.

$$d = \frac{( j + f ) !}{j ! \times f !} \qquad [ Math . 11 ]$$

If the example described above is applied, the following relationship is obtained. The number of combinations Nopt of trips in the example can be expressed as follows.

$${N}_{opt} {=}_{6} {C}_{2} = \frac{6 !}{4 ! \times 2 !} = 10 \qquad [ Math . 12 ]$$

In this manner, according to an embodiment of the invention, optimization can be performed by computing only ten patterns.

According to an embodiment of the invention, it is determined whether or not the trips obtained by segmenting a vehicle operation schedule by timings close to the target time can be structured without a residue using a target structuring number. If there is a residue, only the residual trips are combined. Therefore, it is possible to reduce the number of combinations and perform computation at high speed to find an optimum combination.

As a result, it is possible to prevent influence on a trip time caused by a route condition, and dependence on block segmentation points or timings for a relief place and a vehicle operation schedule. For this reason, an individual condition setting for each railway company is not necessary. In addition, it is possible to remarkably reduce the number of combinations necessary in the trip structuring. Therefore, it is possible to perform the processing at high speed.

Alternatively, instead of a computer solely employed as described above in conjunction with FIG. 4, the system according to the present invention can be configured in a distributed manner through a network such as the Web 16A or the Cloud 16B as illustrated in FIG. 5. In the latter case, if many people are employed to operate equipment, it is possible to optimize duty or rostering of the employees. In particular, if time zones of the equipment to be managed are spread apart, it is possible to process the scheduling at high speed although it is difficult to achieve optimization.

While railway scheduling has been described by way of example in the aforementioned embodiment, the present invention may also be modified to other crew scheduling or rostering plans for managing many employees, such as crew scheduling of other transportation systems such as buses or taxis, and delivery scheduling of a mail delivery service or a transit industry.

The crew members may be various employees such as a tour conductor, a pilot, a cabin crew member, and a heavy industry operator without limiting to a driver or a conductor.

While several embodiments of the invention described hereinbefore are just for illustrative purposes and are not intended to limit the scope of the invention. Those embodiments may be modified in various forms, and various omissions, changes, substitutions may also be possible without departing from the scope and spirit of the invention. The embodiments and their modifications are included in the scope and the spirit of the invention, which is to be given the full breadth of the appended claims and any and all equivalents thereof.

1. A crew scheduling system comprising:
a block segmentation unit configured to obtain a segmentation number for segmenting a vehicle operation schedule from a departure to a terminus of the vehicle in the unit of a predetermined target time, compute costs of each trip segmented by the segmentation number at any one of a plurality of predetermined segmentation candidate points, determine a segmentation point having the lowest cost, and segment the vehicle operation schedule into the trips; and
a duty structuring unit configured to set a consecutive structuring number of the trip segments, determine whether or not the segmentation number is evenly divided by the consecutive structuring number for each of the vehicle operation schedules, enumerate patterns of combinations of consecutive trips structured by the consecutive structuring number and residual trips for the vehicle operation schedule in which the segmentation number is not evenly divided by the consecutive structuring number, structure trips in the unit of the consecutive structuring number by combining the residual trips of each of the patterns and residual trips of each of patterns of other vehicle operation schedules, compute costs of the block structured in the unit of the consecutive structuring number when the block structured in the unit of the consecutive structuring number are within a predetermined range of the structured block allowable time, and select the block structured with the lowest cost as a crew duty .

2. The crew scheduling system according to claim 1, wherein the costs are calculated on the basis of a crew member on-duty time, a trip time, a rest time of the computation target block.

3. The crew scheduling system according to claim 1, wherein the target time is a value for roughly setting the segmentation point.

4. The crew scheduling system according to claim 1, wherein the target time is an upper limit value serving as a prohibition range.

5. A crew scheduling method comprising:
obtaining a segmentation number for segmenting a vehicle operation schedule from a departure to a terminus of the vehicle in the unit of a predetermined target time;
computing costs of each trip segmented by the segmentation number at any one of a plurality of predetermined segmentation candidate points, determining a segmentation point having the lowest cost, and segmenting the vehicle operation schedule into the trips;
setting a consecutive structuring number of the trip segments;
determining whether or not the segmentation number is evenly divided by the consecutive structuring number for each of the vehicle operation schedules;
enumerating patterns of combinations of consecutive block structured by the consecutive structuring number and residual trips for the vehicle operation schedule in which the segmentation number is not evenly divided by the consecutive structuring number; and
structuring block in the unit of the consecutive structuring number by combining the residual trips of each of the patterns and residual trips of each of patterns of other vehicle operation schedules, computing costs of the block structured in the unit of the consecutive structuring number when the block structured in the unit of the consecutive structuring number are within a predetermined range of the structured block allowable time, and selecting the block structured with the lowest cost as a crew duty.
